(19) United States
(12) Patent Application Publication
(10) Pub. No.: US 2025/0160239 A1
(43) Pub. Date: May 22, 2025

(54) AUTONOMOUS FARMING DEVICES, SYSTEMS AND METHODS

(71) Applicant: MTI Technologies Pty Limited, Wangara (AU)

(72) Inventors: Benjamin Carl Scott-Robinson, West Dean (GB); Samuel James Watson Jones, West Dean (GB); Josey Ross Allnut, West Dean (GB); Nemo Kenneth James William Harry Scott-Robinson, West Dean (GB); Andrew Starkey, West Dean (GB)

(73) Assignee: MTI Technologies Pty Limited, Wangara (AU)

(21) Appl. No.: 18/897,461

(22) Filed: Sep. 26, 2024

Related U.S. Application Data
(63) Continuation of application No. 17/689,886, filed on Mar. 8, 2022, now abandoned.
Application No. 17/689,886 is a continuation of application No. PCT/GB2020/052191, filed on Sep. 10, 2020.

(30) Foreign Application Priority Data
Sep. 10, 2019 (GB) 1913076.4

(51) Int. Cl. A01B 69/00; A01B 39/18

(52) U.S. Cl. CPC A01B 69/004; A01B 39/18

(57) ABSTRACT

Methods, systems 1 and devices such as robots 8, 9 for farming are disclosed. An autonomous monitoring robot is configured to traverse a farm plot and generate, from a sensor set of the monitoring robot, a farm plot data set. The farm plot data set is processed to generate operating instructions for a tending robot. The tending robot is arranged to execute the operating instructions so as to traverse the farm plot and performs tending tasks on it including such as seed-planting, weeding, and applying crop treatments such as fertiliser, fungicide, herbicide or pesticide.

### CROSS REFERENCE TO RELATED APPLICATIONS

This application is a continuation of U.S. patent application Ser. No. 17/689,886 filed on Mar. 8, 2022 (Our Ref. ELKINER-P0006C1); which is a continuation of International Patent Application No. WO PCT/GB2020/052191 filed on Sep. 10, 2020; which claims priority to UK Patent Application No. GB1913076.4 filed on Sep. 10, 2019; the entire disclosures of which are hereby incorporated by reference and relied upon.

### BACKGROUND OF THE INVENTION

Field of the Invention. The present invention relates to systems and methods that relate to farming robots that are predominantly in the form of driverless agricultural vehicles capable of autonomously traversing arable land. In particular, such farming robots are configured to perform farming operations on arable land, such as monitoring, applying crop treatments, seeding and/or weeding.

Description of Related Art. Modern farming techniques rely on the use of tractors. These are used to haul large and heavy agricultural machinery for many purposes, including ploughing and tilling operations to reduce the compaction of soil.

Tractors are necessarily large and heavy, making them power inefficient. This coupled with their typical usage of hydrocarbon-based fuels also make them noisy and polluting. Their weight compacts the soil, and the mechanical operations that they typically perform kill or otherwise disturb wildlife, such as birds, insects and worms, which provide benefits to arable land.

Furthermore, tractors and associated machinery must be operated manually. This sets significant limits on the agricultural work that can be performed with them with regard to safety, speed, accuracy, work-hours and efficiency. The use of tractors and other large farming equipment is impossible on certain types of land—especially those restricting movement (e.g. via obstacles or uneven ground). Accordingly, the creation of new farm land often necessitates operations such as levelling and deforestation.

Modern farming techniques also tend to employ indiscriminate crop treatment techniques, such as the blanket applications of additives such as pesticide, fungicide, herbicide and fertilisers. This has many drawbacks. Such additives are often expensive, and so their application in areas that do not need them is wasteful. Also unused additives can adversely affect the environment, with run-offs entering the water table and leading to the deterioration of wildlife and biodiversity. Conversely, if such additives are not sufficiently concentrated in the areas that need them the most, their use is ineffective, or worse—pest and weeds may develop tolerances to additives intended to kill them.

It is against this background that the present invention has been conceived.

### BRIEF SUMMARY OF THE INVENTION

According to a first aspect of the present invention there is provided a farming method utilising at least one autonomous farming robot. Specifically, the farming method may utilise autonomous farming robots that operate to monitor and/or tend to a farm plot. Preferably, the method comprises at least one of: monitoring the farm plot to generate at least one farm plot data set and processing the at least one farm plot data set to generate instructions for tending the farm.

Moreover, the method preferably comprises monitoring the farm plot with at least one autonomous monitoring robot. Ideally, the autonomous monitoring robot traverses the farm plot and generates, from a sensor set of the monitoring robot, at least one farm plot data set.

The farming method may comprise monitoring the farm plot with at least one monitoring module. Each monitoring module may be deployed at respective single location within the farm plot over a predetermined period. Each monitoring module may be configured to generate, from a sensor set of each monitoring module, at least another farm plot data set for processing.

The method may further comprise processing at least one farm plot data set to generate operating instructions for a tending robot. Advantageously, the tending robot is separate from the monitoring robot, allowing an efficient division of automated farm labour.

Furthermore, the method may further comprise executing the operating instructions at the tending robot. In response to this, the tending robot preferably traverses the farm plot and performs tending tasks on it. Ideally tending tasks that can be performed by the tending robot include at least one of: seed-planting, weeding, and applying crop treatments such as fertiliser, herbicide, fungicide or pesticide.

Preferably, the farm plot data set is transmitted from the monitoring robot to a server, and the server processes the farm plot data set to generate operating instructions for the tending robot, and transmits those operating instructions from the server to the tending robot for execution.

It should be noted that there may be a plurality of tending robots and/or a plurality of monitoring robots: the method supports multiple instances of robots, servers and other features. Moreover, these can interoperate to perform different but collaborative tasks, especially when situated on a common farm plot. Additionally, the method may apply to multiple farm plots.

Moreover, the method may comprise processing the farm plot data set to generate operating instructions for a plurality of simultaneously-operable tending robot; and executing the operating instructions at the plurality of tending robot so that the they simultaneously traverse the farm plot and perform tending tasks on it.

Preferably, the operating instructions comprise an operating schedule that specifies a time or period over which farming robots are to perform operations such as tending and monitoring.

The farming method may comprise situating a servicing station on the farm plot.

The servicing station may be arranged to provide automatic servicing to farming robots. For example, the servicing station may be configured and arranged for replenishing their energy sources, transferring data, refilling consumables, switching tools and/or switching task configurations.

The farming method may comprise calculating an operations limit for a farming robot beyond which that farming robot requires servicing at the servicing station to continue effective performance of its monitoring and/or tending operations. The operations limit may be calculated as a function of at least one of:
a location of the respective farming robot;
a traversable range of the respective farming robot;
tasks to be performed by the respective farming robot;
a memory usage of the respective farming robot;
a measured power level of the respective farming robot;
an operating schedule to be followed by the respective farming robot; and
a detected consumable quantity of the respective farming robot.

Additionally, such operating limiting parameters may be measured periodically to determine a change in these parameters over time. This can also be used in the calculation of the operations limit. For example:
a location of the respective farming robot over time, and thus a speed or direction;
a task performance rate by the respective farming robot;
a memory usage rate of the respective farming robot;
a measured power level drain of the respective farming robot; and/or
a consumable quantity usage of the respective farming robot.

Following calculation of the operations limit, effective servicing of a farming robot can be advantageously achieved.

The calculation of the operations limit may be performed outside of the respective farming robot—for example, at the server. Accordingly, the method may comprise the communication of at least one operation limiting parameter from a farming robot, to a device that calculates the operations limit. Specifically, the method may comprise the farming robot being arranged to communicate at least one operation limiting parameter to the server. In response, the server can calculate the operations limit in dependence on those one or more operation limiting parameters. Operation limiting parameters that are received from the farming robot may include: a location, a measured power level, and/or a detected consumable quantity of the farming robot.

More generally, the farming method may further comprise determining the respective locations of the servicing station and a farming robot for which the operations limit has been calculated. Accordingly, the method may further comprise determining a route for that farming robot that returns it to the location of the servicing station before exceeding the operations limit. Naturally, the method may also comprise guiding that farming robot across the farm plot in accordance with the determined route to the servicing station for servicing, and then servicing that farming robot at the servicing station. Naturally, such guiding can include executing instructions on the farming robot to cause it to move along the determined route.

Various servicing operations may be automatically performed at the servicing station. For example, the servicing station may comprises a battery-swapping station at which an exhausted battery of a farming robot can be exchanged for a charged battery during an automatic servicing of the farming robot at the servicing station.

The servicing station may comprise a memory, and is configured to transfer data, such as at least one farm plot data set, from a memory of the farming robot to the memory of the servicing station during an automatic servicing of the farming robot at the servicing station.

The servicing station comprises a tool-servicing station at which a tool of a tending robot can be exchanged for another during an automatic servicing of the tending robot at that servicing station. Consumables of a tending robot may be refilled at the tool-servicing station during an automatic servicing of the tending robot at the servicing station.

The operating instructions ideally comprise task waypoints. Preferably, each task waypoint specifies a tending task to be performed at an associated location. Thus, the tending robot receiving and executing the operating instructions may thereby traverse the farm plot to perform tending tasks at their respective specified locations.

The operating instructions may be modified to take into account the presence of multiple farming robots especially when operating simultaneously within the farm plot. In particular, routing and/or task waypoints may be modified to promote efficient division of a set of automated tasks to be performed by those multiple robots, and also to minimise adverse interactions, such as collisions.

One further example is modifying the operating instructions for multiple farming robots to ensure that their servicing schedules—and thus utilisation of a common servicing station—do not significantly overlap. If multiple farming robots cannot simultaneously utilise a common servicing station, then the operating instructions for each of those multiple farming robots can be modified such that routing schedules govern sequential rather than simultaneous use of the servicing station.

The farming method may be adapted to the capabilities of the farming robots, most notably, the functions that they are able to perform in one configuration as compared to another. For example, the tending robot can be reconfigured with different tool sets so that in one configuration, it is able only to plant seeds as a task; in another configuration, only perform weeding tasks; in yet another able only to apply a particular kind of additive (e.g. one of pesticides, fungicide, herbicides or fertilisers); and so forth. The farming method generally may comprise assigning a set of tasks to be performed at a series of locations that are dependent on the determined capabilities of the farming robot. Naturally, a farming robot can communicate when it has successfully entered into a particular configuration to allow such a determination to be made.

Moreover, the farming method may comprise:
determining a first configuration of the tending robot in which it is capable of respective performing only a first restricted set of tending tasks on the farm plot;

calculating a first task route between the location of task waypoints that specify a tending task of the first restricted set; and
executing the operating instructions at the tending robot so that the tending robot when in the first task configuration, traverses the farm plot performing tending tasks of the first restricted set at their respective locations along the first task route.

If the tending robot is capable of switching configuration, then the farming method may, more advantageously comprise:
determining a first and second task configuration of the tending robot in which it is capable of respective performing only a first or a second restricted set of tending tasks on the farm plot;
calculating a first task route between the location of task waypoints that specify a tending task of the first restricted set;
calculating a second task route between the location of task waypoints that specify a tending task of the second restricted set; and
executing the operating instructions at the tending robot so that the tending robot:
   when in the first task configuration, traverses the farm plot performing tending tasks of the first restricted set at their respective locations along the first task route; and
   when in the second task configuration, traverses the farm plot performing tending tasks of the second restricted set at their respective locations along the second task route.

Naturally, the method can extend to additional task configurations. Generalising, the method may comprise:
determining an nth task configuration of the tending robot in which it is capable of performing only a nth restricted set of tending tasks on the farm plot;
calculating a nth task route between the location of task waypoints that specify a tending task of the nth restricted set; and
executing the operating instructions at the tending robot so that the tending robot traverses the farm plot in the nth task configuration, performing tending tasks of the nth restricted set at their respective locations along the nth task route.

Advantageously, the farming method may further comprise switching the tending robot between task configurations (e.g. the first and second task configurations) at a configuration switching location. The configuration switching location ideally defines a waypoint that is common to the task routes to which the configurations relate. For example, the configuration switching location may define a waypoint that is at or after the end of the first task route, and at or before the start of the second task route, and the tending robot switches from the first configuration to the second configuration at the configuration switching location. Moreover, a servicing station is ideally situated at the configuration switching location.

The farming method may comprise determining a schedule for monitoring and/or executing operating instructions. Whilst this is useful for farming robots deployed at a single farm plot, it becomes more important when farming robots are to be deployed across multiple farm plots.

The farming method may be advantageously extended to several different farm plots. In particular, farming robots may be operated to monitor and tend to a plurality of farm plots, and the method may further comprise determining a schedule for monitoring and/or tending for each farm plot. More specifically, the method may comprise at least one of:
registering the location of each farm plot;
determining a routing sequence for at least one transportation vehicle to transport each farming robot to each farm plot;
transporting farming robots using the at least one transportation vehicle in accordance with the determined routing sequence; and
deploying the farming robots, for period between transporting them, at each farm plot for monitoring and tending respectively.

It should be noted that the aforementioned components, features and advantages of the farming method can be adapted to provide a farming system.

In particular, a second aspect of the present invention resides in a farming system for monitoring and tending to a farm plot.

Preferably, the system comprises at least one of:
an autonomous monitoring robot for monitoring the farm plot;
an autonomous tending robot for tending to the farm plot;
a monitoring module;
a network; and
a server in communication with the monitoring and tending robots via the network.

Preferably, the monitoring robot ideally comprises a sensor set. Thus, the monitoring robot may be configured to traverse the farm plot and generate, from the sensor set, at least one farm plot data set. The monitoring robot may also be configured to transmit the at least one farm plot data set of the server.

The server may be configured to generate operating instructions for the tending robot, and transmit the tending instructions to the tending robot. The operating instructions may be generated as a function of processing the at least one farm plot data sets.

Preferably, the tending robot comprising tools for tending to a farm plot. The tending robot may be configured to receive and execute operating instructions, for example, received from the server. The tending robot may configured by the operating instructions to traverse the farm plot, and perform tending tasks on the farm plot using its tending tools. Preferably, tending tasks include at least one of: seed-planting, weeding, and applying crop treatments such as fertiliser, fungicide, herbicide or pesticide.

Preferably, the system further comprises a servicing station situated on the farm plot. The servicing station may be configured and arranged to provide servicing to farming robots. Servicing may include one or more of: replenishing energy sources, transferring data, refilling consumables, switching tools and switching task configurations.

The server and/or the farming robots may be arranged to:
calculate an operations limit for a farming robot beyond which that farming robot requires servicing at the servicing station to continue effective performance of its monitoring and/or tending operations;
determine the location of the servicing station and/or of that farming robot;
determine a route for that farming robot that returns it to the location of the servicing station before exceeding the operations limit; and/or
guide that farming robot across the farm plot in accordance with the determined route to return it to the servicing station for servicing.

Preferably, the operating instructions generated by the server comprise task waypoints. Ideally, each specifying a tending task to be performed at an associated location. Accordingly, the tending robot may be configured to receive and execute the operating instructions thereby traversing the farm plot to perform tending tasks at their respective specified locations.

Preferably, each farming robot comprises at least one of:
a wireless communication module for communicating via the network, ideally to receive operating instructions from the server;
a user interface via which a user can determine an internal state of the farming robot,
and/or via which a user can control the state of, or input information to the farming robot;
a memory configured to store farm sensor data, operating instructions, and other data necessary for the performance of the functions of the farming robot;
a processor for controlling the operation of the other components of the farming robot, ideally governed by operating instructions loaded onto the memory;
a power system for powering the farming robot;
a sensor set for generating farm plot sensor data and/or providing data for use in real-time behaviour control (such as collision avoidance);
an actuator set for providing farming robot movement in response to the operating instructions; and
a propulsion system, driven at least part by the actuator set, to allow the farming robot to traverse a farm plot, ideally guided, at least in part, by the operating instructions.

Ideally, at least one farming robot is configured to traverse the farm plot in dependence on both a remotely-designated predetermined route, and locally-designated behaviour control routines.

Furthermore, the or each tending robot may further comprise at least one of a tool system and a consumable unit. Preferably, the tool system is configured to perform one or more particular tending tasks. Preferably, the consumable unit is configured and arranged to store and/or dispense consumables—in particular those that are utilised by a respective tool system.

One or more monitoring modules of the farming system may comprise at least one of: a sensor set, an energy source, a transceiver, and/or a housing. Preferably, the housing is rod-shaped. Ideally, the housing has a lower portion at which a stake is provided. The stake may be arranged to be driven into the earth at a location on a farm plot at which the monitoring module may be configured to generate farm plot data sets from its sensor set. The monitoring module may be configured to periodically transmit those farm plot data sets via the transceiver, over the network, to the server. Accordingly, the server may be configured to generate operating instructions for the tending robot in dependence on processing the farm plot data set received from the monitoring module.

Preferably, the monitoring robot comprises a sensor assembly on which is supported at least one of the sensors of the sensor set. Preferably, the sensor assembly can be switched between an extended configuration and a stowed configuration, the extended configuration occupying a larger effective volume than the stowed configuration. Preferably, the sensor assembly comprises a boom on which a plurality of the sensors of the sensor set are supported.

Preferably, the boom comprises an extended configuration, and a retracted configuration, the extended configuration extending the boom across a length wider than the width of the monitoring robot. Preferably, the retracted configuration causes the boom to fold into at least one of itself, and a body of the monitoring robot. Preferably, the boom comprises at least one reversibly coupleable component that is situated between the division between two parts of the boom, the reversibly coupleable component allowing the boom to be folded and unfolded between the extended and retracted configurations. Preferably the at least one reversibly coupleable component comprises at least one of: an over-centre latch, and a quick-release pin.

Preferably, the boom comprise a support wire, extending between distal ends of the boom so as to prevent sagging of the distal ends relative to a central part of the boom. The boom may comprise a tensioner for tensioning the support wire.

Preferably, the sensor assembly comprises a linkage for supporting and suspending the sensor assembly relative to a body of the monitoring robot. Preferably, the linkage is actively operable via an actuator to control the position of the sensor assembly relative to the body of the monitoring robot. Preferably, the linkage is actively operable in response to a feedback control loop driven by data generated by at least one sensor of the sensor set. Ideally, the sensor set comprises a distance sensor (such as an ultrasonic sensor) for determining the distance between the sensor assembly, and the ground on which the monitoring robot operated. Preferably, the actuator is configured to actively operate the linkage in response to the data from the distance sensor. Preferably, the actuator is configured to alter the position of the linkage in response to detecting or predicting a change in the movement of the monitoring robot based on data from the distance sensor.

Preferably, the actuator is configured to raise and lower the sensor assembly relative to the ground, with the linkage arranged to substantially maintain the pitch angle of the sensor assembly regardless of whether it is raised or lowered.

Preferably, the boom comprises at least one arm on which sensors of the sensor set are supported. The boom may comprise a stability system. For example, the at least one arm may be pivotally connected to a yoke via a longitudinal pivot, allowing the at least one arm to roll about the pivot to thereby smooth out the adverse effects of side-to-side rocking on the sensors supported on the arm. Preferably, the longitudinal pivot comprises a resilient member, such as a rubber bush, thereby to provide compliance and damping.

The monitoring module and/or one or more farming robots, either alone or in combination with one another, and with or without each of their subsidiary features (where context allows), may constitute further aspects of the present invention.

More generally, it will be understood that features and advantages of different aspects of the present invention may be combined or substituted with one another where context allows. For example, the features of the method described in relation to the first aspect of the present invention may be provided as part of the system described in relation to the second aspect of the present invention, and vice-versa.

Furthermore, such features may themselves constitute further aspects of the present invention, either alone or in combination with one another, and with or without each of their subsidiary features where context allows. Accordingly, features of the or each: server, network, servicing station, transportation vehicle, monitoring module and farming robot may themselves represent another aspect of the present invention, or part thereof.

### BRIEF DESCRIPTION OF THE SEVERAL VIEWS OF THE DRAWINGS

In order for the invention to be more readily understood, embodiments of the invention will now be described, by way of example only, with reference to the accompanying drawings in which:

FIG. 1 is a schematic view of a farming system that includes autonomous farming robots;

FIG. 2 is a schematic block diagram of exemplary farming robots of FIG. 1;

FIG. 3 is perspective overhead view of a farming robot of FIG. 1;

FIG. 4 is overhead plan view of the farming robot of FIG. 3;

FIG. 5 is a side view of the farming robot of FIG. 3 shown together with additional schematically-represented components;

FIG. 6 is a front view of the farming robot of FIG. 5;

FIG. 7 is a perspective side view of another farming robot of FIG. 1, suitable for use as a monitoring robot.

FIG. 8 is a perspective side view of a sensor assembly of the monitoring robot, the sensor assembly being shown in isolation;

FIG. 9 is a perspective front view of the sensor assembly 70 of FIG. 7; and

FIGS. 10 to 23 are various partial perspective or cross-sectional views of the sensor assembly of FIG. 7, or parts thereof.

### DETAILED DESCRIPTION OF THE INVENTION

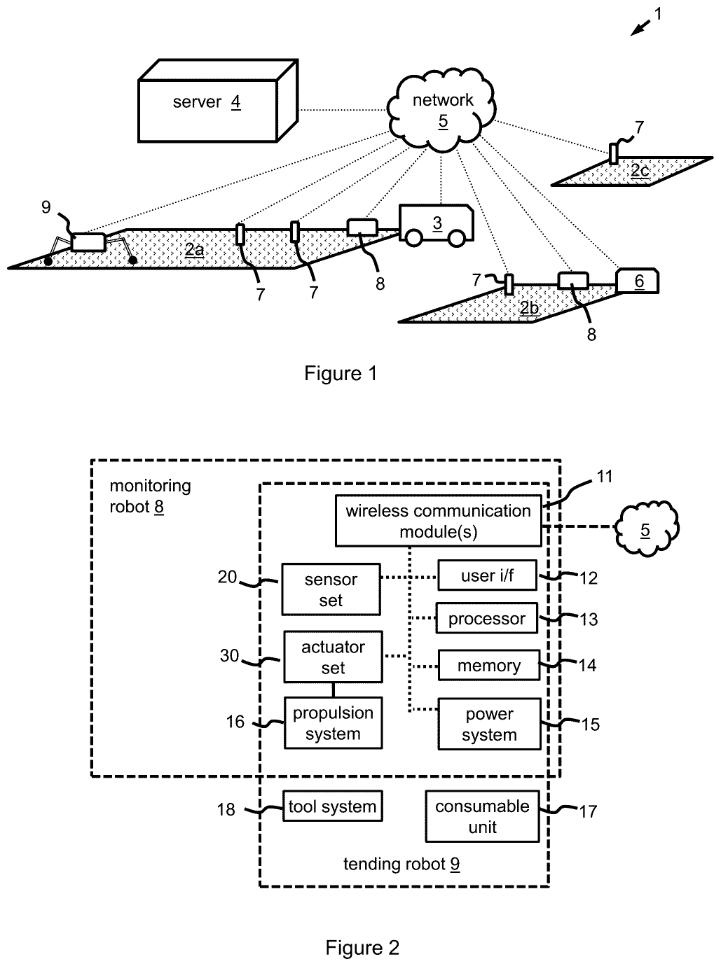

FIG. 1 is a schematic view of an farming system 1 according to a first non-limiting embodiment of the present invention. Other embodiments, and variations to the system 1 and its components will be apparent to those skilled in the art.

The system 1 comprises a transportation vehicle 3, a server 4, a robot base module 6, monitoring modules 7, and two farming robot types 8, 9. Specifically, the farming robots types include a monitoring robot 8, and a tending robot 9.

A communications network 5 communicatively interconnects these components of the system 1. Whilst a single network 5 is depicted in FIG. 1, it may actually be composed of a combination of different communication technologies. Furthermore, a direct communication link between each component of the system 1 isn't always necessary: for example, in certain embodiments, the monitoring robot 8 may communicate only directly with a robot base module 6, which may relay data to other components of the system 1.

The system I may comprise multiples of each features and component, but for simplicity and clarity, only a limited number of each will be described and referred to in the drawings using common reference numerals.

The system 1 comprises an exemplary set of farm plots 2a, 2b, 2c at which the monitoring modules 7 and robots 8, 9 can be deployed. The number of monitoring modules 7 and robots 8, 9, and the times and durations over which they are deployed at each farm plot is both variable and dynamic in response to the farming needs of the farm plots. Thus, the system 1 allows automatic monitoring and tending of land and crops, but with the different components of the system 1 performing a respective autonomous farming service, at different periods to one another.

It will be understood that other components and vehicle types, such as aerostats or drones, are also compatible with the system 1, and can perform supporting functions such as acquiring data sets to allow guidance and targeted operations of the farming robots 8, 9. However, embodiments of the invention described herein are primarily directed to the benefits provided to the system 1 via operation of the farming robots 8, 9.

In the present context, a farming robot 8, 9 may be defined as a driverless agricultural land vehicle capable of autonomously traversing arable land and performing farming operations on it. Such farming operations include passive operations such as monitoring performed by the monitoring robot 8, and active operations as can be performed by the tending robot 9 such as tasks like seeding, weeding, planting and/or applying treatments such as fertiliser.

Importantly, the size of such farming robots are significantly smaller than traditional agricultural machines, such as tractors. By comparison, tractors weigh in the order of tens of thousands of kilograms. The farming robots 8, 9 described herein are small robots—typically weighing many orders of magnitude less. Tending robots 9 typically weigh between 50 and 500 kilograms, and monitoring robots 8 typically weigh between 5 and 50 kilograms. Moreover, the pressure applied to the soil by such farming robots is significantly less than that applied by traditional agricultural machinery, and so this significantly reduces soil compaction and consequential damage.

Tending robots 9 preferably comprise a tool system that, at any one time, is configured to perform a particular tending task. However, the tool system comprises swappable elements, as will be described further below, to allow the tending robot to switch between different tending tasks. In any case, a further weight and energy saving is realised by the tending robot 9 as it is not burdened by having to carry multiple tools for multiple tasks.

It should be noted that monitoring modules 7 described herein are not considered to fall under the definition of “farming robot”. Whilst they perform monitoring akin to monitoring robots 8, they are stationary components of the system 1 and so cannot traverse and monitor a large area as monitoring robots 8 are able to.

Advantageously, the system 1 benefits from the efficient division of automated labour between the different components of the system 1. The inventors have determined that certain farming services, such as tending, need not be performed in the traditional way—so long as such tending is targeted and carried out in response to monitoring. Furthermore, it has been determined that tending need not necessarily be carried out as frequently, or for as long as monitoring.

This has led to the concept of dividing the execution of farming services across heterogeneous components of the system 1, and in particular, allowing the ratio between the number of tending robots 9, monitoring robots 8 and monitoring modules 7 to be varied to account for the required frequency and duration of their respective activities.

Moreover, fewer tending robots 9 are required than monitoring robots 9. Advantageously, this means the capabilities of the larger and more complicated tending robots 9 are not wasted on performing farming services that can be carried out by smaller, cheaper and more fuel-efficient components such as the monitoring robots 8. A similar relationship may apply between the more complex but less numerous monitoring robots 8 and the cheaper, simpler monitoring modules 7.

There isn't necessarily a constant ratio between the time that needs to be dedicated to one service as compared to another, on any one farm plot. Many influencing factors such as climate, farm plot size, crop type and many others can change the ideal time and duration that each farming service is performed per plot. To account for this, embodiments of the present invention allow different farm plots to be maintained via a variable combination of the components of the system 1—the farming robots 8, 9 in particular-leading to the advantageous delivery of “farming as a service”.

By way of example, and with continued reference to FIG. 1, monitoring robots 8 and monitoring modules 7 can first be transported to and deployed at a farm plot (e.g. plot 2b) to survey the extent of that plot, generating farm plot data sets that can be analysed by the server 4. Depending on the size of the plot, and the detail of the survey, a monitoring robot 8 may be deployed for several hours, days or weeks, and then can be moved to another plot to perform a similar monitoring operation, and generate a further set of farm plot data.

The farm plot data sets are transmitted to and processed by the server 4 for various purposes, and in particular to make determinations about how and when the system 1 should be further operated.

For example, the server 4 may determine a suitable location to place one or more monitoring modules 7, and issue instructions to enable deployment of at least one monitoring module 7 at an appropriate determined location at a specified time and/or over a specified period. Instructions may be computer-readable instructions, such as operating instructions that are transmitted to one of the farming robots for the automated placement and/or retrieval of the monitoring modules 7. Alternatively, the instructions may be in the form of human-readable guidance, for guiding a human operator to manually place and/or retrieve the monitoring modules 7.

Many other automated, semi-automated or manual operations can be driven by the server 4 by issuing computer-readable instructions, human-readable instructions, or a combination of the two.

The server 4, in the present embodiment, takes the form of a remotely-located computing system, which may be implemented, for example, via cloud-computing resources. However, in alternatives, the server may be implemented, at least in part, via a computing device situated on the farm plot. In particular, computing functions, such as the processing of first-order farm plot data, can be performed by the local computing device that is situated on the farm plot to generate derived second-order farm plot data, and the second-order farm plot data can then be transmitted to a remotely-located computing system for further processing. Advantageously, this allows high-memory and bandwidth-intensive first-order farm plot data to be converted into relatively low-memory/bandwidth second order farm plot data, obviating the need to transmit such first-order farm plot data. An example of first-order farm plot data could be a set of image data files, with the derived second-order farm plot data being exemplified by text representing objects identified in those image data files. Such second-order farm plot data can be generated via image recognition processing by the locally-located computing device of the first-order farm plot data. Ideally, such a computing device may be located at the robot base module 6.

A monitoring robot 8 samples data snapshot from across a large area of a farm plot—i.e. each snapshot is captured at a single instance, or otherwise over a limited time period. Conversely, each monitoring module 7 is arranged to sample data at a single location within the plot over a significantly longer time period, and may be left as a relatively permanent means of monitoring at a farm plot (e.g. plot 2c). Thus, the monitoring robot 8 is intended to monitor a farm plot at a relatively high spatial, but low temporal resolution, whereas each monitoring module 7 is intended to monitor a farm plot at a relatively high temporal, but low spatial resolution. Their complementary use in combination with one another provides advantageous way of monitoring a farm plot, and generating useful farm plot data sets.

In response to monitoring, whether by monitoring robot 8 or monitoring module 7, the server 4 may determine an optimal time to deploy one or more tending robots 9.

Each of the monitoring modules 7, monitoring robots 8, and tending robots 9 may be transported between farm plots 2a, 2b, 2c via transportation vehicle 3 at times and for periods designated by the server 4. Furthermore, the server 4 may register the location of each farm plot and determine an optimal routing sequence for the transportation vehicle 3, including which components of the system should be picked up or dropped off at each farm plot. This includes robots 8, 9, monitoring modules 7, and also robot base modules 6. Furthermore, the transportation vehicle 3 may also be stationed at a particular farm plot (e.g. 2a) for a predetermined period. Notably, both the transportation vehicle 3 and the robot base module 6 can define “servicing stations” for the robots 8, 9.

The robots 8, 9, are incapable of continuously performing all of their functions without receiving servicing of some type—for example, replenishing their energy sources, transferring data, refilling consumables, switching tools and/or task configurations. Accordingly, servicing stations-whether provided as part of a transportation vehicle 3 or in the form of the robot base module 6—provide a location that the farming robots 8, 9 can visit in order to be serviced. Furthermore, many servicing functions that are performed at the servicing station can be performed autonomously.

As alluded to above, the server 4 may process data (including farm plot data sets) to generate instructions for controlling the operation of other system components. This includes data acquired by monitoring robots 8, monitoring modules 7, and other data sources (e.g. climate/weather forecast data). The processing by the server 4 of such data may be via a machine learning model, the data being fed as inputs into the machine learning model.

Additionally, the machine learning model can be configured to generate instructions as an output as to how the other system 1 components should be configured and arranged to maximise beneficial attributes of farm plots 2a, 2b, 2c, such as crop yield. To this end, such beneficial attributes of farm plots 2a, 2b, 2c may be fed back to the server for the training of the machine learning model.

For example, the server 4 may comprise a user interface via which farmers or other users are able to send to the server the crop yield, profits, revenue, or other metrics they have generated from a respective farm plot 2a, 2b, 2c. Such metrics can be used as feedback of a reinforcement learning loop of the machine learning model. This can be used to improve future instructions and guidance issued by the server 4 to other components of the system 1.

As mentioned, instructions can be issued in various forms. For example, human-readable guidance may be issued by the server 4 via a user-interface device to guide human users to take actions, for example:
a farmer to stock or replenish certain farming materials (e.g. held at a servicing station); the transplantation of a monitoring module 7; and/or
a driver to operate the transportation vehicle 3 to relocate one or more system components, such as farming robots 8, 9, to another farm plot.

Alternatively, the instructions may cause automated responses by the other components of the system 1. In particular, instructions can include operating instructions transmittable to a respective robot, and executed thereon to govern the operating behaviour of that robot 8, 9, such as the following of a specified route and/or performance of a specified task. Naturally, the operating instructions may comprise a schedule that specifies a time or period over which robots are to perform tasks and operations such as following a route.

For example, a tending robot 9 may receive operating instructions from the server 4 that comprise task waypoints defining a task route. The tending robot 9 can then follow the task route, moving between locations defined in each task waypoint, to tend to particular plants or zones within a farm plot 2, 2b, 2c, within which it is deployed. Similarly, a monitoring robot 8 may receive and follow operation instructions to follow a monitoring route, and so analyse an area from which data is required.

In general terms, farm land use optimisation can take place, with the server 4 providing instructions and guidance, for example, about which areas are best used for which crops, and which other areas are, on balance, best left fallow.

An additional benefit of the present autonomous farming method and system 1, is that autonomous farming operations can be performed at all hours of the day and night, obviating the need for farming operations to be carried out intensively during daylight hours under supervision of a human operator. Night-time operation has other benefits, including the ability to utilise a lower tariff of mains/grid electrical energy.

Additionally, night-time operation itself is enabled by small, farming robots 8, 9 that are significantly quieter and less disruptive than traditional agricultural machinery and equipment.

Components of the system I will now be described in greater detail.

The monitoring module 7 can take on a variety of forms. At its most basic, the monitoring module 7 comprises an energy source, at least one sensor for generating data sets about the farming environment in which the monitoring module 7 is placed, and a wireless transceiver via which those data sets can be transmitted to the server 4. Furthermore, the monitoring module comprises a weather-proof housing, allowing deployment in the outdoor farming environment. The housing is preferably in the form of a rod. One version of the monitoring module 7 comprises at its lower portion, a penetrating stake that can be easily driven into the earth. This allows the monitoring module 7 to be deployed in the form of an elongate upright device, and so facilitate visibility of the monitoring module 7.

In general, the monitoring module 7 is designed to be easily visible, whether by robotic or human vision, allowing it be easily located for avoidance and/or retrieval. In particular, the housing of the monitoring module 7 may be coloured in contrast to its typical earth-coloured surroundings (e.g. with bright, contrasting and/or fluorescent colouring).

The wireless transceiver is located at the upper portion of the monitoring module 7, maximising the wireless communication range of the monitoring module 7. Each of the lower and upper portion of the monitoring module 7 can comprise sensors, allowing detection of properties of both soil (at/near the stake below the ground), and air respectively. The monitoring module may also comprise a solar-powered energy generator, allowing both replenishment of its electric energy source, and also serving as a sensing means to measure intensity of sunlight over time.

The sensor set of the monitoring module 7 can measure parameters such as: sound, images, elevation, air pressure, location, temperature, air quality, soil composition, gas composition, soil volatile organic component composition, nutrient levels, moisture, and many others. The sensor set may also measure parameters relating to the internal state of the monitoring module, such as an electrical power level of the energy source. These parameter can be correlated with one another, typically time-correlated, via storing the values measured by the sensors in conjunction with a timing reference accessible to the monitoring module 7. This can take the form of a simple on-board electronic timer, or the timing reference can be acquired wirelessly (e.g. via GPS signals).

Certain parameters can be processed in accordance with specific pattern recognition techniques for the purposes of inferring indicators about the condition and health of an area around the monitoring module 7. For example, pattern recognition of images and audio can be used to infer the presence of certain wildlife, such as worms, insects and birds which may, in turn, be useful in assessing potential benefits or harms to an area around the monitoring module. Further combinations of parameters can also provide indicators about an area. For example, the combined use of image data and the detected presence of predetermined volatile organic compounds within soil can provide more reliable indicators of certain wildlife inhabiting the soil than either one parameter alone.

In various embodiments, the monitoring module 7 may comprise a user interface for allowing a user to control a state of, or input information into the monitoring module 7. In the present embodiment, a basic user interface is provided, allowing a user to determine the on/off state of the monitoring module, and further operate it to turn the monitoring module 7 on or off. The user interface also provides feedback about the internal state of the monitoring module 7, for example using externally-visible display indicators about the housing to represent a power level of the monitoring module 7, and/or error codes for troubleshooting. The display indicator comprises a dot-matrix style display for this purpose.

The monitoring module 7 comprises a processor for processing at least a portion of the data generated by its local sensors, and can compress such data for storage within a local memory, and subsequent transmission via the wireless transceiver to the network 5.

Nonetheless, the main benefits of the data generated by monitoring modules 7 is derived when the data is transmitted to and processed at the server 4, as this data can be combined with data from the other components of the system 1, in particular from external data sources, and also data captured by the farming robots 8, 9.

FIG. 2 is a schematic block diagram of exemplary farming robots of FIG. 1. Both a monitoring robot 8 and a tending robot 9 are schematically represented in FIG. 2, with the principle features that they have in common being represented, for brevity, using the same blocks and reference numerals. However, it should be understood that whilst the different types of farming robots 8, 9 share many of the same principle features, the specific way those principle features are implemented in each farming robot 8, 9 will vary. For example, as the monitoring robot 8 is smaller than the tending robot 9, its principle components for movement are smaller.

Each farming robot 8, 9 comprises at least one wireless communication module 11 for wireless connection to the network 5. Each farming robot 8, 9 also comprises a user interface 12, a processor 13, a memory 14, at least one power system 15, a sensor set 20 and an actuator set 30. These components are electrically and communicatively connected to one another, in particular with the processor 13 governing their interoperation.

The farming robots 8, 9, have many of the same features and functions of the monitoring module as described above. In particular, the farming robots 8, 9 have and operate a similar sensor set 20. Furthermore, the way data can be stored, processed and transmitted using the memory, processor and wireless communication module 11 is broadly the same.

However, farming robots 8, 9 are distinguished from static monitoring modules 7 predominantly due to their mobility, and ability to perform operation across a wide area. For this, farming robots 8, 9 have an actuator set 30 at least part of which is mechanically connected to a propulsion system 16. This is presently embodied by a combination of electric motors, wheels and all-terrain tyres. These components allow the farming robots 8, 9 to move, and components such as those of the sensor set 20 are further arranged to allow farming robots 8, 9 to autonomously navigate and map their environment, for example via techniques such as SLAM (simultaneous localisation and mapping).

To this end, the sensor set 20 may comprise radio-localisation sensors such as GPS (e.g. RTK GPS), as well as inertial measurement units (IMUs) for determining the position, orientation and acceleration of the farming robots 8, 9, and their independently moveable component parts such as legs and other appendages. The sensor set 20 may be mounted via a suspension system to minimise vibrations caused by traversal of uneven or rough terrain, and enhance the determination of said position, orientation and acceleration. To this end, the suspension system may be actively controlled.

The sensor set 20 ideally comprises environment scanning sensors, such as LIDAR and sonar to allow the farming robots 8, 9 to navigate and map their environment, potentially building a digital model of it (e.g. a so-called “digital twin”). The processor 13 is configured to execute routing and obstacle avoidance routines that utilise inputs from such sensors and, in response, control the actuator set 30 and propulsion system 16, so that the farming robots 8, 9 take an optimal path across a farm plot during operation. Routing and other autonomous farming robot behaviour can therefore be governed by the processor executing general routing instructions as well as other behaviour control routines.

More specifically, the behaviour of the farming robot is preferably governed by a combination of locally-designated and remotely-designated routines or instructions.

Locally-designated behaviour control routines are instantaneously responsive to and dependent on the immediate surroundings of the farming robot, as detected by its sensor set. Accordingly, the exact behaviour or movement of a farming robot, as controlled by such locally-designated behaviour control routines, isn't specified in advance, but rather is determined in response to its environment, in real-time. Examples of such behaviour control routines include collision avoidance.

By contrast, remotely-designated instructions—such as routing instructions that are part of operating instructions generated by the server—do specify, in advance, a set of instructions to be followed by the robot. However, the instructions are provided in a generalised form that allow the farming robot to simultaneously follow those general instructions whilst also being guided by locally-designated behaviour control routines.

In other words, the remotely-specified instructions ideally provide general operation guidance that is specifically implemented locally by the robot. For example, the remotely-designated instructions may comprise a general predetermined route that the farming robot is to follow. However, deviation from this route is allowed under control of the locally-designated behaviour control routines to avoid obstacles not foreseen by the original remotely-designated instructions.

It should be noted that, to reduce latency, it is desirable to ensure that the necessarily more instantaneous behaviour control routines are designated locally. However, in principle, such control routines could, in theory, be designated via a source remote from the robot. However, the speed and bandwidth of communication required to achieve this currently makes it a far less-optimal solution.

In any case, routines and instructions, especially those that are remotely-designated are received via the wireless communication module 11, in the form of operating instructions. These are sent from authorised controllers, such as the server 4. The authority of the controller are protected and verified via security protocols and encryption between a robot and the controller. General routing information originating from the server 4 can be part of a set of operating instructions generated by the server 4 and transmitted to a respective robot. However, routing information or instructions may also originate from other sources. For example, an operator, such as the owner of a farm plot, may be the source of routing information to farming robots 8, 9. In particular, the system 1, either via a local computing device, or via the server 8, may provide a routing interface via which an operator interacts to generate routing information. The routing interface receives inputs from an operator, for example allowing shapes to be drawn over a map of the farm plot presented by the routing interface. In response the routing interface generates routing information that that defines geographic boundaries and geometry of a farming plot. This can ensure that the farming robots 8, 9, receiving that routing information, confine their operation to a predesignated farming plot. The routing interface also allows an operator to specify no-go areas (e.g. water-courses, buildings or other obstructions) to improve the efficiency and ease with which the farming robots 8, 9 can traverse appropriate portions of a farm plot. Additionally, the routing interface allows an operator to distinguish between different areas of a farm plot, and thereby differentiating those areas in terms of priority, interest, or nature of operation.

It should be noted that the routing interface may be at least partly automated, in that it is able to determine—e.g. by applying image recognition routines to an aerial image of a farm plot—where boundaries, paths, obstructions and other features significant to the routing of the farming robots are likely to be. In this case, the routing interface can automatically annotate the map, and present the automatically annotated version of the map to an operator for verification or correction, prior to generating routing information from it.

The generation of such routing information, prior to the deployment of either of the farming robots 8, 9, is primarily useful to allow for the efficient deployment of the monitoring robot 8. It, in turn, can gather farm plot data for use by the server 4 in generating additional operating instructions, that may include better routing information than can be achieved from a aerial survey.

Furthermore, operating instructions generated by the server 4 and sent to a tending robot 9 also include task waypoints, each specifying a task to be performed at a location within a farm plot.

Task progress information can be transmitted back to the server from the farming robots 8, 9. Advantageously, this enables the route taken by each robot 8, 9 across a farm plot 2a, 2b, 2c to be controlled dynamically by a task allocation system. If it is determined that the length of the route, or number of tasks performed by the robot is likely to be less (or more) than originally predicted before the robot 8, 9 depletes one of its resources, then its instructions can be altered.

Moreover, this can be in response to the reported progress made by a team of robots 8, 9 simultaneously undertaking a particular task (e.g. monitoring and/or tending). The task allocation system is firstly configured to set an initial task and/or routing program for each robot 8, 9, and transmit route and/or task instructions to each respective robot. Secondly, the task allocation system receives periodic updates from those robots 8, 9 about the progress they have made in following a route or completing a task. Thirdly, the task allocation system applies adjustments to the task and/or routing program for each robot 8, 9 and retransmits program updates to the relevant robots 8, 9, altering their original route and/or task instructions so that a goal performed by the group of robots can be performed more efficiently.

In preferred embodiments, the sever 4 comprises the task allocation system. However, in alternatives, the task allocation system may be implemented at another device, for example situated on or near the farm plot. Similarly, the task allocation system may be provided at one of the other components of the system 1, or distributed across more than one component, with control adjustments being performed by a distributed system. In particular, the task allocation system and/or robots 8, 9 may comprise a swarm robotic agent control system.

Robot navigation can also be assisted via the use of one or more wireless communication modules 11. Communication with other components of the system 1, especially those that are relatively local (e.g. within the same farm plot), and able to transmit their own location, can be used as a further means of radio-localisation (e.g. using triangulation, time-of-flight or other suitable collaborative localisation means).

Furthermore, such localised communication can provide other advantages, such as minimising the size and power consumption of communications equipment, and furthermore providing a localised mesh network, wherein components of the system 1 that are local to one another act as communication relays for one another. This is particularly useful for transmitting large data sets that would otherwise require the prolonged use of a relatively high-power transmitters to remotely-located receivers.

The sensing capabilities of the farming robots 8, 9 may also reside in the responses of components of the actuator set 30 and/or propulsion system 16 to environmental stimuli. For example, the farming robots 8, 9 are embodied in present embodiments with four wheels and electric motors, with each motor driving a respective wheel. Rotating component of such electric motors and/or wheels are provided with rotational position sensors. Furthermore, the actuator set comprises power sensors for measuring the power supplied to each electric motor. Advantageously, the combined response from both power and rotational positional sensors, and optionally also other location and position sensors, can be used to infer the effectiveness of the powertrain. From this, certain characteristics of the environment can be inferred. For example, soil conditions (e.g. how soft or moist the ground is) can be inferred from a function of the power supplied to each wheel, and its rotational movement in response: typically, harder, drier soil will require less power than softer, more saturated soil. To maintain the accuracy of such inferred characteristics, each farming robot 8, 9 may undergo a calibration routine to determine a typical power/rotation response for each wheel under predetermined conditions (e.g. loading, gradient, speed), and from that, data from these power/rotation sensors can be used to generate a model of the condition of the ground traversed by the robots 8, 9 during their operation.

The change in ground conditions over an area such as a farm plot can provide indicators of metrics such as water accumulation, uptake and drainage. As alluded to previously, the data captured by these and other sensors of the sensor set 20, or the derivative information determine from those sensors (e.g. relating to ground conditions) can be transmitted to the sever 4 for use as inputs into a machine learning model.

As mentioned, sensors of the sensor set 20 of the farming robots 8, 9 can be similar to those of a monitoring module 7, in that they can measure parameters such as: sound, images, elevation, geolocation, temperature, air quality, soil composition, nutrient levels, moisture, and others.

In the same way as described above, data generated by the sensor set is registered against a timing reference, so that different sensor data can be temporally correlated with one another with respect to time. However, sensor data is also registered against a position reference, and so different sensor data can be spatially correlated with one another with respect to location.

Advantageously, this means that measurements taken at the same location (but at different times) can be directly compared with one another to determine the difference between the measurements, and so how measurable attributes at that location have changed over time. This is useful for imaging and, in particular, visually-determining the rate of growth of weeds and crops: Many problematic weeds tend to grow faster than their surrounding crops and yet, due to mechanisms such as Vavilovian mimicry, are difficult to distinguish from a visual inspection at a single moment in time. Accordingly, tracking the rate of growth of plant-life allows such weeds to be identified. Moreover, their precise location can be determined so that a tending robot 9 can be deployed to remove those weeds.

The sensor set 20 includes a set of image sensors that detect visible light (i.e. typical RGB camera images) as well as those that can detect into other electromagnetic spectra, such as those of infrared and/or ultraviolet wavelengths. The sensor set 20 may include a hyperspectral scanner for use in monitoring the health of crops, the distribution and uptake of crop treatments such as pesticides, fungicide, herbicides and fertilisers, and/or the presence of wildlife such as pests. In particular, attributes that lead to the health or detriment of crops will leave a corresponding specified hyperspectral fingerprint. The generation of that fingerprint during scanning thus provides an indicator of how a particular area of a farm plot is currently faring, and also how it is likely to develop in the future.

The spatial correlation of data generated by such imaging or scanning sensors can provide information about how specific crops or other areas within a farm plot have evolved over time.

Naturally, multiple images may be captured by the sensor set 20 at the same instance, for example, using two or more separate image sensors. The relative field of view of such image sensors can be predetermined, so as to allow depth to be inferred from such instantaneously-generated image sets. Alternatively, one or more separate depth sensor may be used in conjunction with the image sensors. Regardless, three-dimensional image capture can be achieved. Furthermore, such three-dimensional image capture can be hyper-spectral/multi-spectral. Such data can be sent back to the server 4 for use in an algorithm for the detection of a variety of conditions concerning crops. In particular, weeds such as blackgrass, emergent in cereal crops, can be detected.

To maximise the benefit of such data, it should be understood that the farming robots 8, 9 are arranged to track both the general location of the robot 8, 9 as a whole, but also the position, orientation and configuration of sensors such as imaging sensors that may be relevant to the ability to spatially correlate data sets captured at different times. For example, if a camera can be positioned independently to the robot (e.g. via an arm and/or pivotable actuator), or even if a zoom level of the camera can be reconfigured, the farming robots 8, 9 are configured to register this data to allow spatial matching to be carried out more effectively. It is preferable for this to be performed locally to the robot 8, 9 and, if performed in real-time, may benefit self-localisation and mapping procedures. Nonetheless, spatial matching may also be performed remotely by the server 4.

The user interface 12 of the farming robots 8, 9, like the monitoring modules 7, facilitate the dynamic exchange of information between the robots 8, 9 and humans conventionally authorised to interact with the robots (e.g. farmers, operators and/or supervisors).

However, the user interface of the farming robots 8, 9, incorporate additional interaction elements that are important for interactions with other “unauthorised” entities. Such unauthorised entities may include adults, children, pets, livestock and other wildlife. Accordingly, the term “user interface” should be interpreted broadly in the present context when so provided with such interaction elements.

In particular, the farming robot 8, 9 may be configured to register, via its sensor set, the presence of an unauthorised entity, and take an appropriate interaction action in response. For example, when the unauthorised entity is detected to be human, the farming robot 8, 9 may cease farming operation, and issue a visual or audio notification about the operation of the farming robot 8, 9, for example providing feedback that their presence has been detected, and the consequential response by the robot 8, 9 or supervisor. For example, a live communication link (e.g. audio or video link) may be established via the user interface 12 of the farming robot 8, 9 between a detected unauthorised entity, and a remotely-located authorised entity such as a human operator.

If the farming robot 8, 9 is situated in an area where non-operator individuals are expected to be found (e.g. where there is a public right-of-way) then reassurances may be provided automatically to such individuals—e.g. about the safety of operation of the farming robot 8, 9. If individuals are not expected in a particular area then a guidance or security action can be taken, such as notifying that individual how to travel back to a public footpath, and potentially notifying an authorised entity of the presence and location of the unexpected individual.

Pets and livestock may prompt similar reactions-primarily chosen to preserve the well-being of both the farming robot, and the pets or livestock. Detection of other wildlife will typically lead to other appropriate responses, such as capturing images for documenting the existence of that wildlife—for example for the purposes of environmental conservation.

The power system 15 of the farming robots 8, 9 ideally comprise at least one electric battery, and a power management system. In particular, the power system of the farming robots 8, 9 may comprise a primary battery and a secondary battery, with the primary battery being capable of storing a higher level of electrical power than the secondary battery. The power system 15 may also comprise energy generation means, such as solar panels.

In one embodiment, the primary battery is physically and electrically connected to the farming robot 8, 9 via a battery interface that is configured to allow the primary battery to be controllably and automatically decoupled from the robot 8, 9 and so replaced with another replenished primary battery. Specially, the battery interface is arranged to receive a battery disengagement signal, and in response perform a physical operation such as unlocking of the battery from a chassis of the robot 8, 9. The exhausted primary battery can then be swapped for a charged primary battery.

Preferably, such a battery-swapping operation is carried out autonomously. The farming robot 8, 9 approaches and aligns itself relative to a battery-swapping station, and a battery swapping operation is carried out via relative movement and interaction between the battery-swapping station and the robot 8, 9. Moreover, additional movements may be performed by the robot 8, 9, under power of the secondary battery, to enable automatic disengagement of one exhausted primary battery, and engagement of another charged primary battery. Such a battery-swapping station is preferably provided as part of, or located near to a robot base module 6, and draws power from it to recharge one or more exhausted primary batteries. In turn, the robot base module 6 is preferably connected to a mains/grid energy source and/or connected to renewable energy sources.

Thus, the robot 8, 9 can quickly replenish its energy source, and so can be redeployed to carry out its tasks more quickly than having to wait to recharge a battery. Nonetheless, in alternative embodiments, the robot 8, 9 can simply dock with the robot base module 6 over a period for the purpose of recharging the primary battery.

Advantageously, the robot base module 6 may be provided as part or an extension of the transportation vehicle 3. Furthermore, the robot base module 6 may provide other servicing interactions with the farming robots 8, 9 instead of, or in addition to replenishing their energy source. Notably, this can include the transfer of data from the memory 14 of the robot 8, 9 to a memory of the robot base module 6. This can then be transmitted onward to the server 4. Moreover, once the data has been transferred from the robot 8, 9 to the robot base module 6, the memory 14 of the robot 8, 9 can be erased or overwritten to allow capture of further data about a farm plot.

Advantageously, the robot base module 6 effectively acts as a memory buffer between the farming robot 8, 9 and the server 4. Thus, the burden of wireless transmission time and energy is shifted from the robot 8, 9, to the robot base module 6. This is particular significant in areas where there is poor wireless connectivity.

One method of data transfer between a farming robot 8, 9 and the robot base module 6 may be via a short-range, high-bandwidth communication system. For example, one of the wireless communication modules 11 of the farming robots 8, 9 may be configured to communicate with a complementary communication module at the robot base module 6 when they are within sufficient range. When coming within range, the wireless communication modules enable sensor data transfer from the memory 14 of a farming robot 8, 9 to the memory of the robot base module 6.

Another method of data transfer between a farming robot 8, 9 and the robot base module 6 may be via wired transfer—with the robot 8, 9 electronically docking with the robot base module 6 for the purpose of transferring data. Complementary electrical connectors may be provided on the farming robot 8, 9 and the robot base module 6 for this purpose. During docking, recharging may also conveniently take place, and furthermore, electrical connectors may also provide the means through which a farming robot battery is recharged.

A further method of data transfer between a farming robot 8, 9 and the robot base module 6 may be via physical exchange of a full memory module with an empty memory module.

The above-described features may be present in both types of farming robot—i.e. both the monitoring robot 8 and the tending robot 9. However, to reap better rewards from the division of automated labour, it is generally preferred that the monitoring robot 8 has a more sophisticated and extended use of sensors, covers a larger area, and/or stores a higher resolution of data than the tending robot 9. The monitoring robot 8 is exclusively for the purpose of acquiring data about a farm plot 2a, 2b, 2c.

In contrast, and with continued reference to FIG. 2, the monitoring robot 8 is not provided with additional components of the tending robot 9, such as a consumable unit 17 and a tool system 18.

The consumable unit 17 includes a storage container—such as a hopper—for containing farming consumables, and a mechanism by which those farming consumables can be dispensed from the storage container. This consumable unit 17 may take on one of many forms. For example, the consumable unit 17 may be arranged to contain and dispense additives such as pesticide, fungicide, herbicide or fertilisers. The consumable unit 17 may be arranged to contain and dispense seeds. Furthermore, the consumable unit 17 is provided with a consumable quantity detector via which the quantity of consumable can be electronically registered by the tending robot 9 and also communicated to other components of the system 1.

The structure and function of the tool system 18 may be complementary with the consumables held and to be dispensed by the consumable unit 17. For example, if the consumable unit 17 holds additives in liquid form, the tool system 18 may comprise an additive spraying tool. If the consumable unit 17 is arranged to contain and dispense seeds, then the tool system 18 may comprise a planting device.

One tool system 18 of the tending robot may comprise a electrical weeding device that is arranged to apply electrical energy to weed targets. The electrical weeding device preferably comprise a high-power electrical pulse generator coupled to electrode applicators. In use, the tending robot 9 is arranged to determine a weed to be destroyed, guide at least one the applicators towards a location of the determined weed, and enable the electrical pulse generator so that an electrical pulse is transmitted through the weed. In particular, the tending robot 9 positions the electrode applicators at either end of the weed to be destroyed—potentially, with one electrode applicator being driven into the soil and/or being electrically connected to a lower or root portion of the weed to be destroyed, and the other directed towards an upper part of the weed—typically growing above the soil. Advantageously, this can destroy the root system of the weed. The tool system 18 may comprise other weeding devices, such as those that apply heat or mechanical energy to remove weeds.

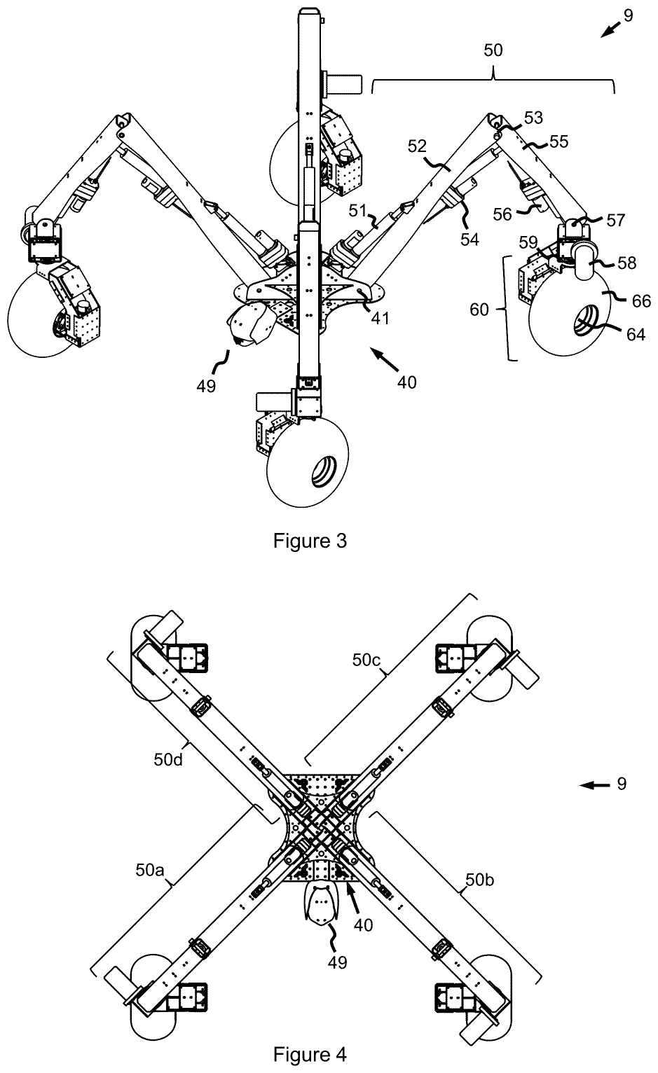

FIGS. 3 to 6 show a particular implementation of a farming robot adapted to be suitable for use as a tending robot 9.

Referring to FIGS. 3 and 4, the robot 9 generally comprises a body 40, legs 50, wheel assemblies 60 and a head 49.

Conveniently, the legs 50 and wheel assemblies 60 are constructed from an identical set of component, simplifying manufacture and control of the robot 9. Accordingly, the foregoing reference to features of one of the legs or wheel assemblies should be understood to be applicable to the others.

The head 49 is mounted at an end of the body 40 notionally designated as a front end. Each leg 50 is connected at a corner region of the body 40. Specifically, a front-right corner supports a front-right leg 50a, a front-left corner supports a front-left leg 50b, a rear-left corner supports a rear-left leg 50c, and a rear-right corner supports a rear-right leg 50d. The legs 50 generally extend away from the body 40 along two vertical planes that are approximately orthogonal to one another. The front-left and rear-right legs 50b, 50d lie in one plane, and the rear-right and front-left legs 50a, 50c lie in the other plane. Each leg 50 extends away from the body 40 and terminates at a respective wheel assembly 60.

An articulated leg 50 is generally composed of an upper leg 52 and a lower leg 55, which are pivotably connect to one another via a knee joint 53. A hip joint 41 pivotably connects the upper leg 52 to the body 40. A first linear actuator 51 acts between the body 40 and the upper leg 52 so that linear movement of the actuator 51 causes a change in the pivot angle between the upper leg 52 and the body 40 about the hip joint 41. In a similar way, a second linear actuator 54 acts between the upper leg 52 and the lower leg 55, changing their relative pivot angle about the knee joint 53. A third linear actuator 56 acts between the lower leg 55 and an ankle 58, changing the pivot angle about an ankle joint 57.

The ankle 58 supports a rotational ankle actuator which is arranged to control the yaw orientation of a respective wheel assembly 60 relative to the ankle 58 about a foot joint 59. The foot joint 59 rotates about a broadly vertical pivot axis relative to a level ground on which the robot 9 is shown to be supported. Each wheel assembly 60 comprises a wheel box 62, a wheel 64, and an all-terrain tyre 66. Each wheel box 62 houses an electric motor for driving a respective wheel 64 and tyre 66 along the ground.

The linear actuators, rotational actuators and electric motors effectively form part of the actuator set 30 schematically shown in FIG. 2. These can be controlled via the processor 13 to allow the robot 9 to perform movements such as varying the spacing between the body 40 and wheel assemblies 60, and also the relative height between the body 40 and ground that the robot 9 is traversing. The pitch and roll of the body 40 relative to the ground can also be controlled.

The independently-pivotably wheel assemblies 60 (i.e. about the foot joint 59) facilitate the cases with which the wheel assemblies 60 can converge or diverge from one another. For example, each wheel 64 can be oriented for rotation about the same plane as its respective leg 50, and from this orientation, driving the wheel 64 using its respective electric motor in one direction will urge the wheel directly towards the body 40, and away from the body 40 when driven in the other direction. Thus, the electric motor of each wheel assembly 60 can be used to augment the power and action of the linear actuators.

When the wheel assemblies 60 maximally converge—i.e. are near as possible to one another and the body 40—the robot is in a compact configuration so that the effective footprint or span of the robot 9 is minimal. In such a configuration, the upper leg 52 and lower leg 55 are folded towards one another, and each is oriented close to a vertical orientation. Such a compact configuration is useful for the purpose of allowing the robot 9 to fit into small spaces. Importantly, the compact configuration enables two robots of the type shown in FIGS. 3 to 6 to be stored within the confines of the transportation vehicle 3, which in the present embodiment is envisaged to have internal storage dimensions of approximately 1.9 m×1.8 m×3.5 m (height, width, length)—i.e. the typical storage of a long-wheel-base L3 H2 van.

When the wheel assemblies 60 are maximally divergent, and the robot 9 is in a fully-extended configuration, the distance between any two adjacent wheels is approximately three metres, and so the “footprint” of the robot 9 occupies approximately 9 m2.

When deployed for operation on a farm plot, the configuration of the robot 9 is typically varied between the compact and fully-extended configurations in dependence on ground conditions and the operation that the robot 9 is set to perform. Notably, it is advantageous to be able to control the variability of wheel track spacing, and wheelbase as this allows the robot 9 to tend to different farm plots that may have different crop row spacing.

Furthermore, the ability to change the effective height of the body 40 of the robot 9 facilitates monitoring and tending. For example, the head 49 of the robot 9 houses a sensor cluster that includes many sensors of the sensor set 20 of the tending robot 9. These allows the robot 9 to autonomously monitor and traverse its environment. The height of the body 40—and so the height of the sensor cluster within the head 49—allows the robot 9 to get closer to the ground to perform more concentrated analysis of a small region of ground, or further away to perform a broader analysis of a wider expanse of ground.

The effective height of the body 40 of the robot 9 is also controlled in dependence on whether the robot is in a configuration in which components or apparatus are mounted to it-in particular when such components are mounted below the body 40.

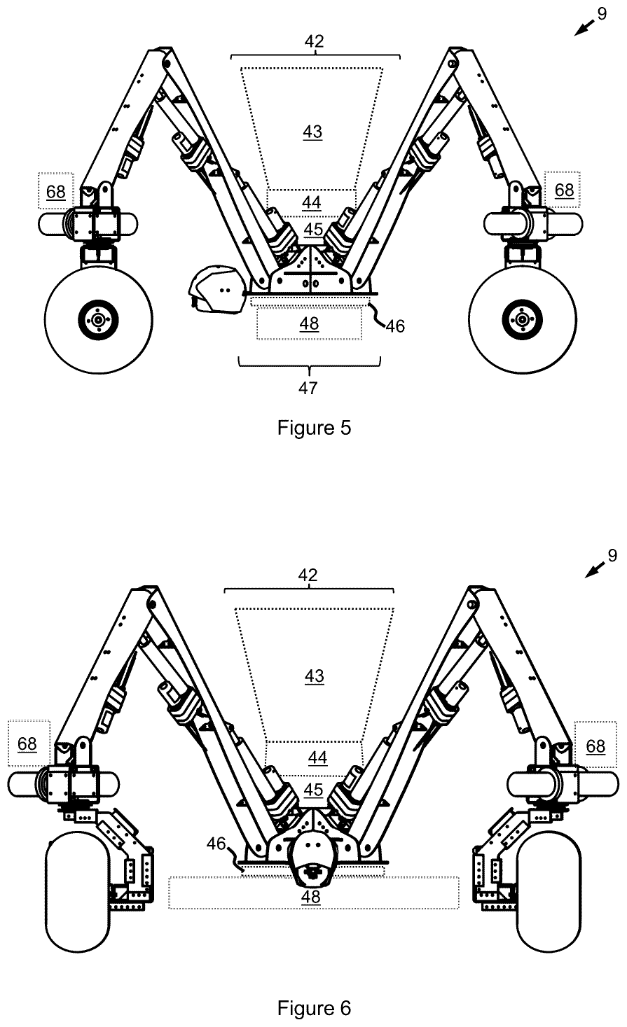

FIGS. 5 and 6 show the farming robot 9 of FIG. 3 together with such additional components or apparatus that are mounted to various parts of the robot 9. These components are schematically represented by dotted-outline shapes. FIG. 5 is a side view and FIG. 6 is a front view. In general, these components may be part of the consumable unit 17 and/or tool system 18 described briefly above.

The robot 9 generally comprises top-mounted units 42 configured and arranged to be mounted to and on top of the body 40, and under-mounted units 47 configured and arranged to be mount to and underneath the body 40. The under-mounted units 47 generally comprise a lower connector 46 and tool system 48 which form part of the tool system 18 generally referred to in FIG. 2.

The top-mounted units 42 comprise an upper connector 45, a primary power source 44, and a consumable unit 43. Additionally, secondary swappable power sources 68 can be mounted to each wheel assembly 60. The consumable unit 43 may comprise a consumable store such as a hopper for containing powers, liquids and/or seeds, and is configured to allow dispensing from that consumable store to a target.

The upper and lower connectors 45, 46 ideally comprise electromechanical connectors that utilise electromagnetic couplings to controllably engage and disengage connection to the body 40 of the robot 9. This allows autonomously-releasable electromechanical connection between the main body 40 of the robot 9 and one or more of the top-mounted 42 or under-mounted units 47. i.e. the connector is configured to receive an engagement or disengagement control signal to engage or disengage a unit, and is respectively responsive by energising an actuator to engage with, or disengage from a corresponding unit.

The upper and lower connectors 45, 46 are ideally configured and arranged to define a consumable feed line between the consumable unit 43 and the tool system 48. For example, consumables such as seeds can be fed through the consumable feed line and planted by an appropriate tool system. The feed line may be similarly arranged to apply other consumables, such as liquid fertiliser, in which case the tool system 48 comprises a sprayer. To this end, the upper and/or lower connectors 45, 46 defines conduit couplings that align upon connector engagement to form part of the feed line.

The upper and lower connectors 45, 46 are also configured and arranged for the distribution of power between top-mounted units 42, under-mounted units 47 and other components of the robot 9. This includes power from the primary power source 44 to other components, as well as power from the secondary power sources 68 to one or more top-mounted or under-mounted units 42. To this end, the upper and/or lower connectors may comprise electric power contacts that are complementary with mating contacts situated on the body 40. The upper and lower connectors 45, 46 may comprise the battery interface, allowing battery swapping operations to be carried out as described above. The upper and lower connectors 45, 46 can also be configured and arranged for the exchange of control signals and other data between the top-mounted units 42, under-mounted units 47 and other components of the robot 9. To this end, the upper and/or lower connectors may comprise data contacts that are complementary with mating data contacts situated on the body 40. The data and electric power contacts may be integrated as part of a common electrical interconnection system.

Advantageously, the tending robot 9 is capable of switching between tending functions (e.g. seeding and the application of various treatments or additives) via switching one type of consumable unit 43 and/or the tool system 48 for another. Moreover, each swappable consumable unit 43 and/or tool system 48 comprises a common type of connector for interfacing with the complementary upper and lower connector 45, 46 respectively.

Interchangeable tool systems 48 or consumable units 43 can be held at a predetermined servicing station, such as at a robot base module 6. Accordingly, the tending robot 9 is capable of autonomously performing a series of different tasks sequentially by returning to the robot base module 6 to swap components of one tool system 48 or consumable unit 43 for another. Additionally, a consumable unit 43 may simply be refilled when depleted to allow the tending robot 9 to continue performing the same task type.

As mentioned, the tending robot 9 may comprise a consumable quantity detector via which the quantity of consumable within the consumable unit 43 can be detected. Accordingly, it is possible to predict when the consumable unit 43 will be depleted, and guide the tending robot 9 along an efficient route that returns it to the robot base module 6 close to this time. Naturally, the route can be a task performance route.

Consumable usage over time can be predicted as a function of the number of consumable-utilising tasks that the tending robot 9 is scheduled to perform, or otherwise estimated as a function of time and dynamic rate of usage of a consumable. The prediction can be carried out by a task allocation system as discussed above, which can also dynamically control the tending robot 9 to follow an optimal route in response to consumable usage.

The robot base module 6 comprises a consumable refilling system arranged to dock with the consumable unit 43 to allow replenishment of consumables held by the consumable unit 43. For example, when the consumable unit 43 comprises a hopper, the hopper comprises a replenishment gate, typically situated at an upper region of the hopper. The consumable refilling system comprises a hopper interface (e.g. a consumable chute) that can be autonomously guided into registration with the replenishment gate—typically via relative movement between the robot 9 and the hopper interface. Upon registration, the consumable refilling system activates to dispense consumable into the consumable unit 43 to replenish it.

To prevent overfilling, the robot 9 (or another system 1 component) may be arranged to communicate, via one of the wireless communication modules, a quantified request to the consumable refilling system. In response, the consumable refilling system is configured to meter a predetermined quantity of consumable identified by the quantified request. If the tending robot 9 is tasked with performing a tending task that does not necessitate a completely replenished consumable unit 43, then specifying an exact quantity of consumable advantageously saves power for the performance of that task. Naturally, the consumable quantity detector can be used to determine surplus consumable remaining in the consumable unit 43 so that an appropriate quantified request can be issued to consumable refilling system.

As described, the tending robot 9 can be configured to perform different farming tasks, primarily in dependence on the type of tool system 18, 48 and/or consumable unit 17, 43 that it is provided with.

One particular example of such a farming task is the precision planting of seeds. For this task, the tending robot 9 is provided with a consumable unit 43 arranged to store and meter individual crop seeds to the tool system 48. The tool system 48 is controlled and configured to drive each metered seed, without damage, into the soil at a predetermined depth suitable for that crop seed. Furthermore, the tool system 48 allows planting of seeds at measured intervals from one another. In one embodiment, the consumable unit 43 comprises a seed metering system which meters individual seeds from the seed store. The metering system comprises an air flow generator that generates a flow of air within a seed metering passage leading between the seed store and the tool system 48. Seeds are individually introduced into seed metering passage via a seed gate, and are entrained within air flow passing through the passage towards the tool system 48. The seed gate itself is biased towards a closed position, but opens by applying a momentary jet of air against it. Furthermore, the jet of air is applied across a head of a queue of seeds so that the jet of air both opens the gate, and propels the first seed positioned at the head of the queue into the air flow. The air flow transports a seed within it to a planting implement of the tool system 48. Air jets and air flow can be generated by compressed air tanks, air pumps, or a combination of them both.

“Misfiring” of seeds is a particular problem with seed metering devices in general-where seeds fail to pass, under action of actuation means such as air jets, along a designated route between the seed store and the soil. To counteract this, the consumable unit 43 and/or the tool system 48 for planting seeds may comprise seed detectors (such as electronic light gates) that register whether or not seeds have successfully followed a designated route from the seed store into the soil. In response to detecting a seed absence when one is expected, the actuation means can be re-triggered, for example, reapplying a jet of air.

The planting implement of the tool system 48 is arranged to penetrate into the soil and further has a seed outlet positioned at a soil-penetrating region of the planting implement via which seeds can be ejected into and below the soil. Naturally, the route followed by the seed from the consumable unit 43 leads to the seed outlet. In one embodiment, the planting implement may comprise a plough, arranged to be dragged through soil, a leading edge of the planting implement comprising a blade for parting the soil, and a trailing edge of the planting implement comprising the seed outlet for depositing ejected seeds within the furrow left in the wake of the planting implement.

In another embodiment, the planting implement may comprise a punch, actuated by the tool system 48 to perform a reciprocating motion causing the punch to penetrate downwardly into the soil to define a series of pits within the soil. Again, the punch is provided with a seed outlet via which seeds can be ejected into each pit.

Regardless of the specific planting implement, the seed outlet is positioned at a location about the planting implement that avoids clogging of the seed outlet. Specifically, the seed outlet is positioned within a surface of the planting implement that moves transverse to, or away from soil throughout relative motion between the planting implement and the soil during operation.

Accordingly, each seed can be planted at a specific location within a farm plot. Furthermore, parameters such as the time of planting and position of each seed can be individually registered by the tending robot 9, and monitored over time to determine the progress of each crop plant. Slight variations between such parameters can be used to continually determine and refine optimal planting strategies in view of requirements such as the overall health of each crop, and optimal harvesting methods and timing. Naturally, all such information can be used to establish and maintain a digital model (e.g. a “digital twin” of a given farm plot).

In further embodiments, the tending robot 9 may simply incorporate components of a seed drill device, as are currently known in the art.

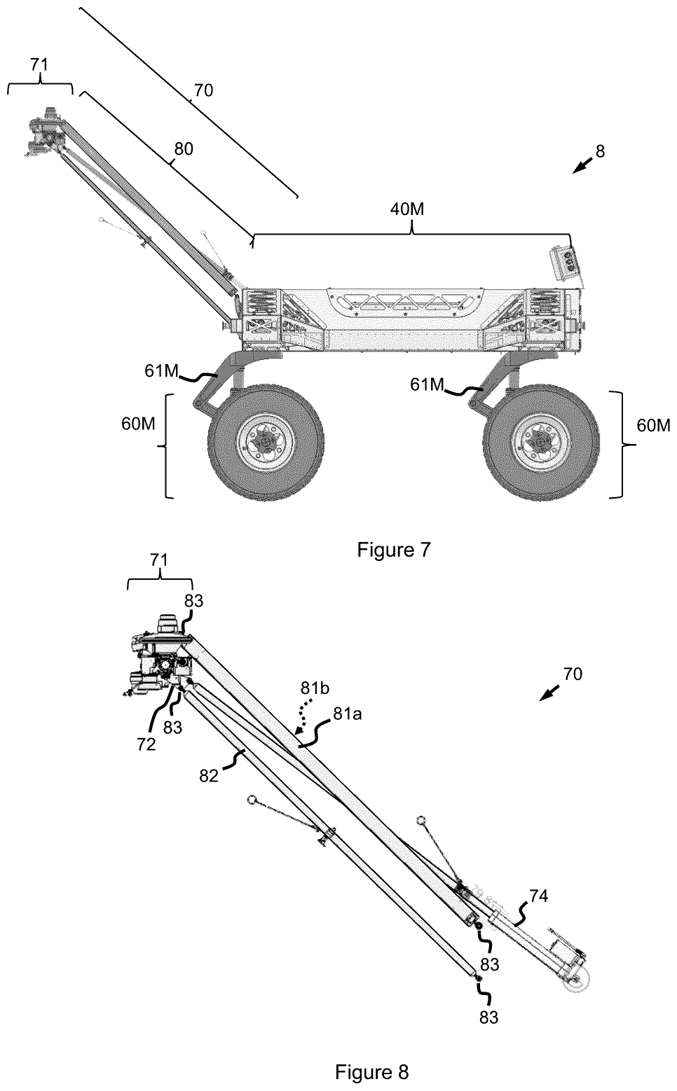

FIG. 7 is a perspective side view of another farming robot, suitable for use as a monitoring robot 8. The monitoring robot 8 is smaller than the tending robot 9 described in relation to FIGS. 3-6, and mechanically simpler in terms of its propulsion system, which is generally arranged in the form of a 4×4 off-road vehicle. The monitoring robot has four wheel assemblies 60M connected via respective wheel suspension 61M to the lower four corners of a cuboid chassis 40M. Its smaller size, relative to the tending robot 9, makes it more agile-allowing it to cover a larger area of a farm plot more quickly for the purpose of data acquisition.

As discussed above, in order to derive better rewards from the division of automated labour, the monitoring robot 8 has a more sophisticated and extended use of sensors, allowing it to store data at a higher resolution than the tending robot 9. To this end, the monitoring robot 8 of FIG. 7 comprises a sensor assembly 70 that enable efficient, reliable and flexible data acquisition about a farm plot 2a, 2b, 2c, including image data in particular.

The sensor assembly 70 comprises a boom 71 on which various sensors of the sensor set 20, and other components are mounted, the boom 71 being connected to chassis 40M via a linkage 80. The linkage 80 is configured and arranged to allow the height of the boom 71 to be controlled, allowing the sensors supported by the boom 71 to be moved closer to or further away from the ground. When closer to the ground, more detailed images of the ground can be obtained, and when further away this allows an image of a larger area to be captured, or otherwise to account for taller plants and other structures. Additionally, the height of the boom 71 can be actively-controlled to reduce undesirable movement of the sensors supported by it relative to the ground. Accordingly, the sensor assembly 70 also acts as a suspension system for its sensors.

Referring to FIG. 8, which is a perspective side view of a sensor assembly 70 in isolation, the linkage 80 comprises a pair of upper struts 81a, 81b, and a lower strut 82. Each strut is connected via a pivot joint 83, at a proximal end, to the chassis 40M of the monitoring robot 8, and at a distal end to a central body 72 of the boom 71. The pivot joints 83 enable rotation of each strut at a respective pairs of horizontal axes, one axis being at the chassis 40M, and the other at the central body 72 of the boom 71. These axes are parallel to one another. The pair of upper struts 81a, 81b share a common first pair of horizontal axes. The lower strut 82 has a second pair of horizontal axes spaced from the first pair. Thus, when viewed from the side, as shown in FIG. 8, the axes about which the struts pivot define the points of a parallelogram, and so the pitch angle of the boom 71 is kept constant relative to the ground regardless of whether the boom 71 is in a raised or lowered position.

The sensor assembly 70 comprises a linear actuator 74, also pivotably-connected between the chassis 40M and the central body 72 of the boom 71. In a similar way to that described above in relation to the components of the tending robot 9, this linear actuator 74 forms part of the actuator set 30 schematically shown in FIG. 2. Accordingly, it can be controlled via the processor 13 to cause raising and lowering of the boom 71. As the linear actuator 74 is controlled to increase in length, the boom 71 is lowered, and conversely, the boom 72 is raised as the linear actuator 74 shortens. Raising and lowering can be performed dynamically, and in response to the actual or anticipated movement of the monitoring robot 8, especially as it traverses rough or uneven terrain. To this end, some of the sensors supported by the boom 71 can be used as part of a feedback control loop to keep the boom 71 steady during traversal of the monitoring robot 8 across a farm plot 2a, 2b, 2c.

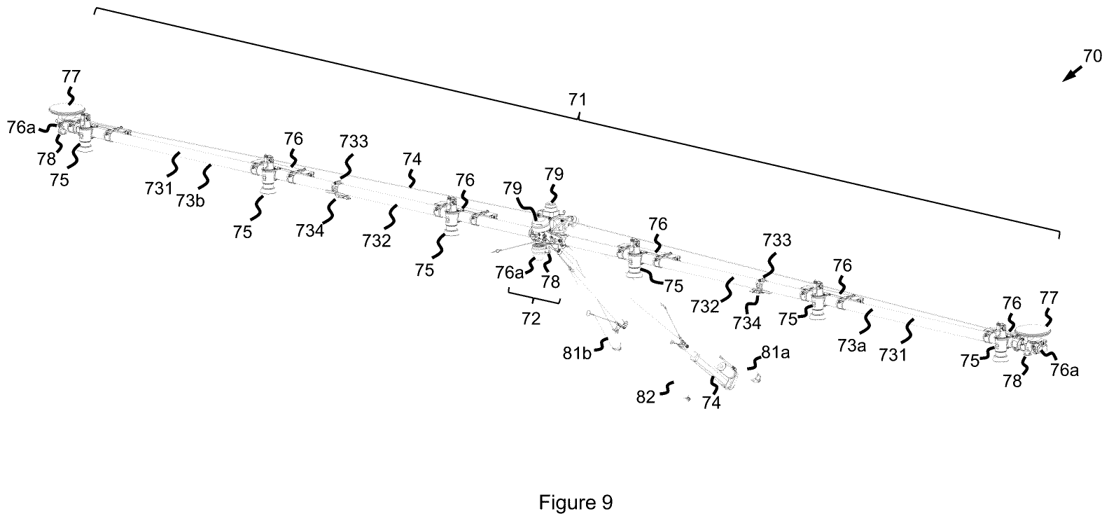

Referring to FIG. 9, which is a perspective front view of the sensor assembly 70 of FIG. 7, the boom 71 comprises a pair of tubular pole arms 73a, 73b connected to and extending in opposite directions away from the central body 72. The pole arms 73a, 73b thus define a horizontal support on which various components of the sensor assembly 70 are mounted. The pole arms 73a, 73b are constructed from a strong lightweight material—ideally a composite material such as a carbon fibre reinforced polymer.

The sensor assembly 70 comprises six camera modules 75, six lighting module 76, indicator lights 76a, positioning units in the form of a pair of RTK GPS modules 77, three ultrasonic sensors 78, and 3D scanners in the form of a pair of LIDAR units 79—each mounted on the boom 71. Naturally, the sensors of such components form part of the sensor set 20 shown schematically in FIG. 2, and thus are used to generate farm plot sensor data, and also for providing data for use in real-time behaviour control-such as collision avoidance, or dynamic boom arm position control.

The boom 71 comprises a support wire 74 for preventing sagging of the pole arms 73a, 73b under the weight of such components, the wire 74 connecting between respective distal ends of each pole arm 73a, 73b, remote from their respective proximal ends at which they are connected to the central body 72. The support wire 74 passes via a tensioner defined on the central body 72 which can be configured to maintain the pole arms 73a, 73b at a desirable orientation relative to one another-which is typically horizontal along a common axis.

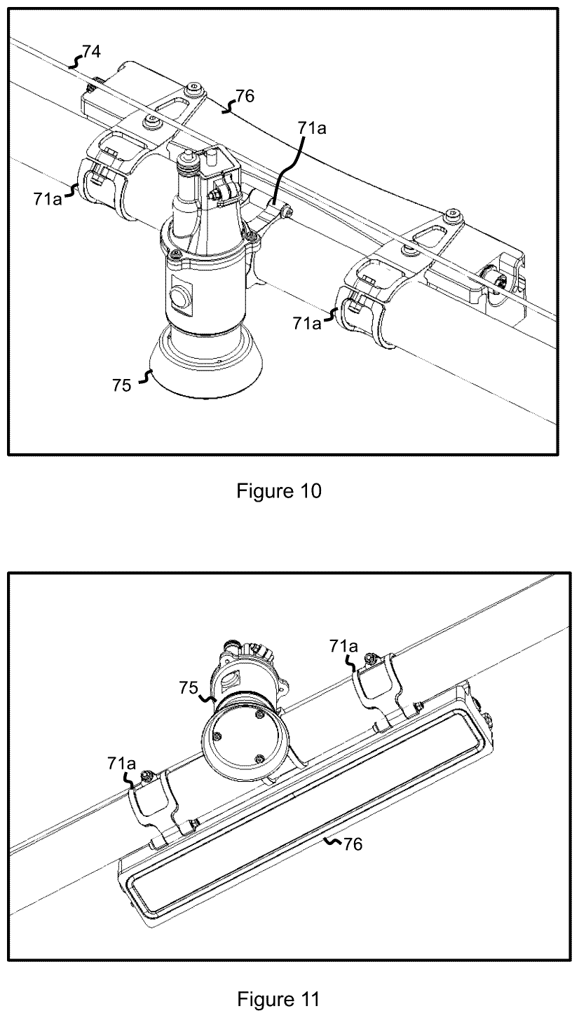

The tubular shape of the pole arms 73a, 73b advantageously allow components to be mounted via tubular brackets onto the arms at various positions along their length, and also these components can be oriented at any angle about a longitudinal axis of a respective arm. Referring to FIGS. 10 and 11, this is facilitated by clamps 71a each of which define a circumferential collar around the tubular arm, thereby allowing attachment of components to the boom 71, as well as the ability to move them longitudinally along, or around the axis of a corresponding arm 73a, 73b.

For example, FIGS. 10 shows an enlarged partial perspective overhead view of the region of one of the pole arms 73a supporting a camera module 75 and a lighting module 76, and FIG. 11 shows a corresponding underneath perspective view. The camera module 75 comprises one of the clamps 71a which attaches around the arm 73a allowing adjustable connection of the camera module 75 to the boom 71. Likewise, the lighting module 76 is held to the boom 71 by a pair of clamps 71a. The lighting module 76 is positioned adjacent to the camera module 75, and pointed downward in the same direction as the camera module 75 thereby to illuminate the ground within the field of view of the camera in low-light conditions. Advantageously, this allows the monitoring robot 8 to reliably traverse a farm plot, even at night, to acquire farm plot sensor data and avoiding obstacles.

Referring back to FIG. 9, the six pairs of camera and lighting modules 75, 76 are distributed evenly along the length of the boom 71, with the fields of view of the cameras being adjacent or even partially overlapping such that composite images of the ground can be derived from the six separate camera modules 75.

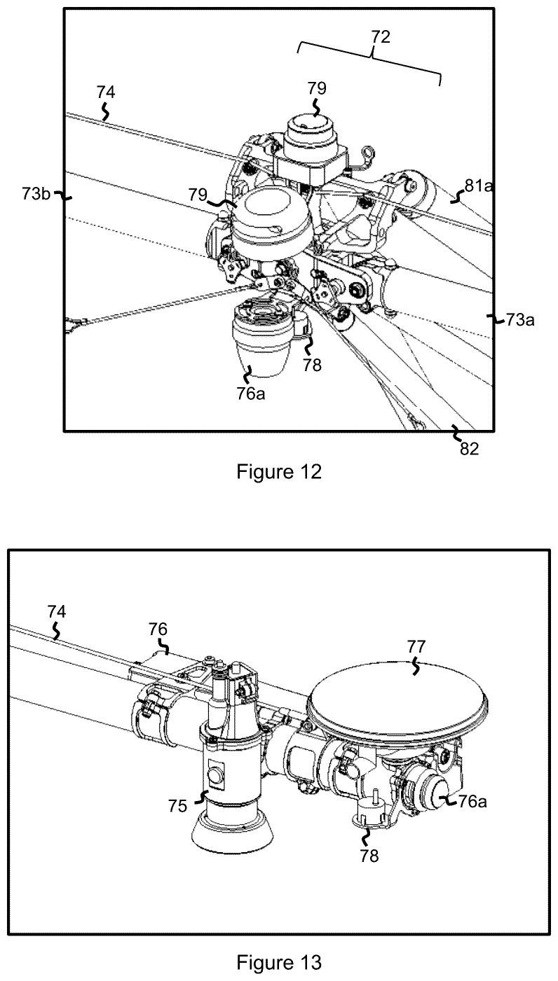

FIG. 12 shows an enlarged partial perspective front view of the central region of the boom 71 where the two pole arms 73a, 73b meet at the central body 72 of the boom 71. Mounted to the central body 72 is one of the three ultrasonic sensors 78, the pair of LIDAR units 79, and an indicator light 76a. The LIDAR units are used to generate a 3D model of the environment being traversed by the monitoring robot as part of its route determination and collision avoidance routines.

The ultrasonic sensor 78 is pointed downward to be able to detect the height of the boom 71, at this central region, relative to the ground directly in front of the monitoring robot 8. As mentioned, this can be used as part of a feedback control loop to allow the active suspension of the sensor assembly 70 as the monitoring robot 8 drives forward. For example, if the ultrasonic sensor detects a sharp dip during forward movement, this can be detected sufficiently prior to the front wheels of the monitoring robot 8 encountering that dip, and acted upon by the suspension control system by controlling the height of the boom 71 to smooth out the undesirable sudden movement that would otherwise be caused by the dip.

FIG. 13 shows an enlarged partial perspective front view of an end region of the boom 71, at a distal end one of the pole arms. Here, the boom 71 supports on the pole arm one of the RTK GPS modules 77, another indicator light 76a, and another one of the ultrasonic sensors 78. A mirrored arrangement is provided at the other end of the boom 71 at the distal end of the other pole arm.

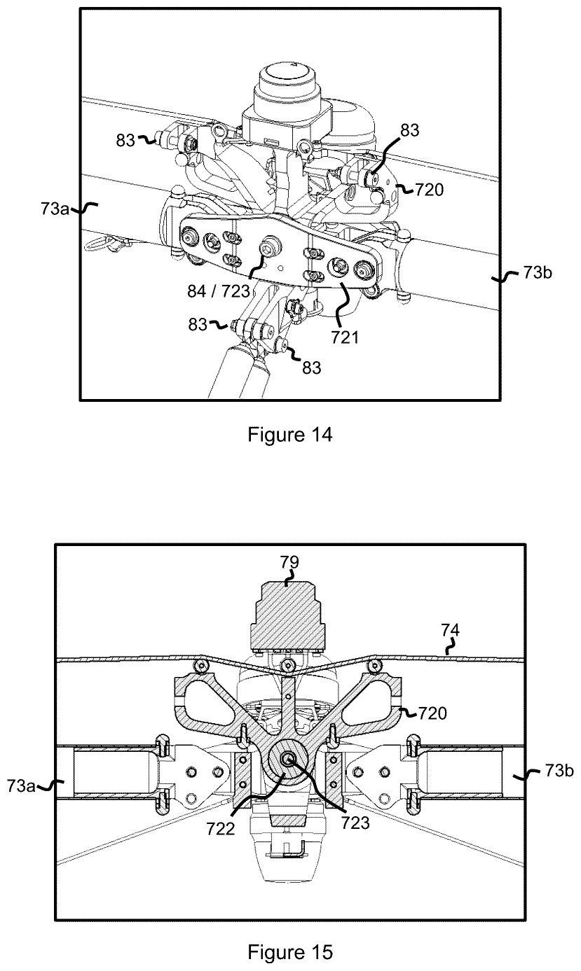

Again, the two end ultrasonic sensors are pointed downwards to be able to detect the height of the boom 71, at these respective end regions, relative to the ground forward of the monitoring robot 8. Accordingly, the roll angle of the boom 71 relative to the ground can be determined, and via a feedback control loop corrected, if necessary, via an active stability system. For example, in certain embodiment, a planetary gearbox and electric motor located within the central body 72 of the boom 71 can be used to keep the two pole arms 73a, 73b, level. In the embodiment of the monitoring robot 8 shown in FIGS. 7 to 23, a passive roll stability system is used instead as will now be described in relation to FIGS. 14 to 18 which are various perspective or sectional view of the boom 71 in the region of the central body 72. In these Figures the upper struts 81a, 81b of the sensor assembly 70 are omitted for clarity.

FIG. 14 is a perspective rear view of the boom 71 at this central region. The central body 72 comprises a yoke 720, a rocking arm 721, a rubber bush 722, and a retaining central rod 723. FIG. 17 also shown a similar view, but with the rocking arm 721 omitted to show the rubber bush 722.

The yoke 720 supports the pivot joints 83 to which the struts 81a, 81b, 82 and the linear actuator 74 are pivotally-connected. These pivot joints 83 are oriented with their axis extending laterally. By contrast, the central rod 723—that defines a further pivot joint 84 that is oriented with its axis extending longitudinally—interconnects the pole arms 73a, 73b, via the rocking arm 721 to the yoke 720. This allows the pole arms 73a, 73b to roll about this pivot 84 relative to the yoke 720, thereby smoothing out the adverse effects of side-to-side rocking on the sensors of the sensor assembly 70.

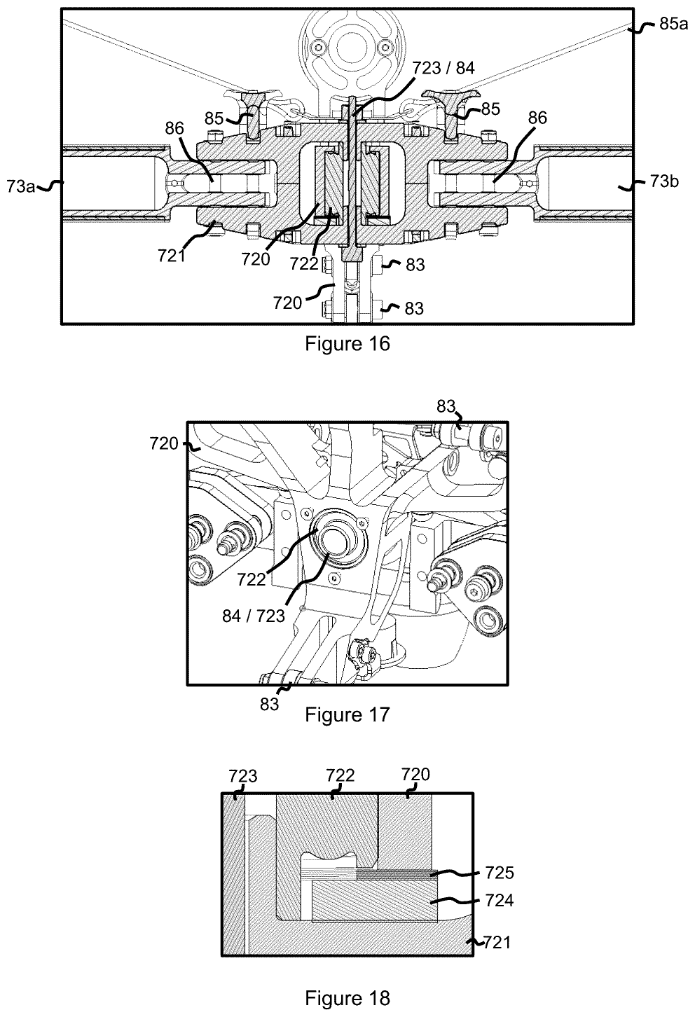

Moreover, and also referring to FIG. 15, which is a partial vertical cross-sectional view of the boom 71, and FIG. 16, which is a partial horizontal cross-sectional view of the boom 71, the rubber bush 722 acts as a resilient interface between the yoke 720 and the rocking arm 721. Specifically, a hollow hub of the yoke 720 snugly accommodates the rubber bush 722 which itself has a cylindrical through-hole into which the retaining central rod 723 is captured, thereby pivotally-connecting the rocking arm 721 via the resilient rubber bush 722 to the yoke 720—and so defining the pivot joint 84.

Advantageously, this ensures the image stability of all camera modules 75 distributed along the length of the boom 71, as the rubber bush 722 provides both compliance and damping to the passive roll stability system. As mentioned, in alternative embodiments, an actuator, such as a planetary gearbox and electric motor may act between the yoke 720 and the rocking arm 721 to enable the roll stability system to be actively controlled.

FIG. 18 show an enlarged partial horizontal sectional view of that of FIG. 16 in the region of where the rubber bush 722 is accommodated by the yoke 720 of the central body 72. The central body further comprises a nylon spacer 724 and shim 725 fitted axially to the rear of the rubber bush 722, between the rocking arm 721 and the yoke 720. As the spacer 724 and shim 725 are less compliant than the rubber bush 722, this reduces the compliance of the interface, and so reduces the predisposition of the rocking arm 722 to move axially (i.e. along the axis of the rod 723) relative to the yoke 720. Moreover, this also restricts undesirable yaw movement of the boom 71 about the resilient rubber bush—which would otherwise lead to one end of the boom 71 to move forward more so than the other end.

In order to facilitate the case with which the monitoring robot 8 can be transported between different farm plots 2a, 2b, 2c, the sensor assembly 70 is collapsible thereby to reduce the effective volume occupied by the monitoring robot 8 when stored for transport. Thus, the sensor assembly has an extended configuration when the robot 8 is in use (i.e. when collecting farm data) and a stowed configuration in which the effective volume occupied by the sensor assembly is significantly reduced for transportation.

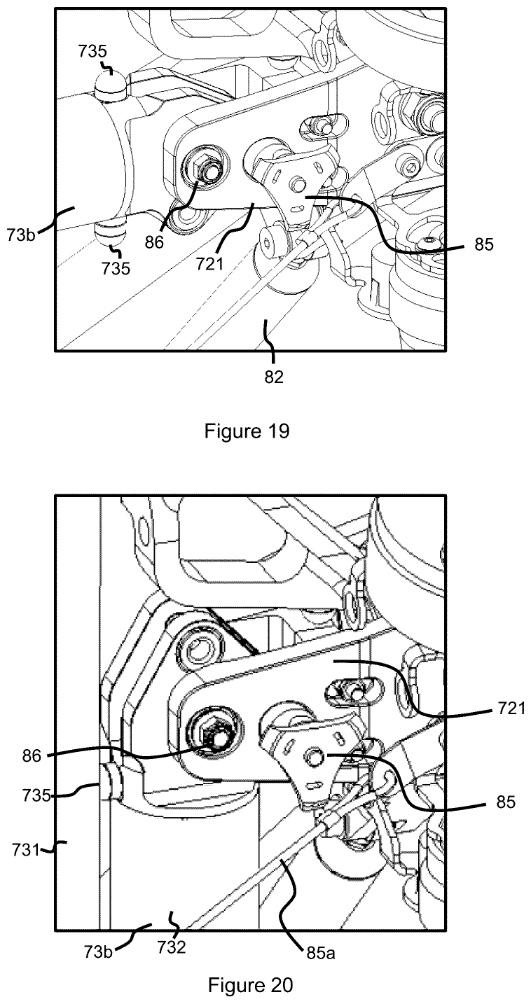

To this end, and referring to FIGS. 19 and 20 which show partial enlarged front perspective views of an interface between one of the pole arms 73a, 73b and the central body 72 of the boom 71, the pole arms 73a, 73b can each be folded at this interface. Specifically, the proximal end of each pole arm 73a, 73b is connected to the rocking arm 721 via two connections: a quick-release pin 85, and a hinge joint 86. The quick-release pin 85 is in the form of a spring-loaded, self-locking ball lock (or pip-pin), having a central plunger that, when depressed, allows withdrawal from or insertion of the pin via aligned bores of the rocking arm 721 and pole arm 73b.

To prevent the pin 85, when complete withdrawn, from become lost or mislaid, the triangle head of the pin 85 is pitted so it is connectable, via a respective lanyard tether 85a, to the main structure of the sensor assembly 70.

When the quick-release pin 85 is inserted into place as shown in FIG. 19, the ends of the rocking arm 721 are fixed at two places to each respective pole arm 73a, 73b, thereby preventing rotation of the pole arm relative to the rocking arm 721. However, when the quick-release pin 85 is withdrawn, such rotation becomes possible.

As exemplified in FIG. 20, this allows a proximal part of each pole arm 73a, 73b to fold in from an extended configuration in which the pole arm 73a, 73b is normally held horizontal during operation, to a retracted configuration in which it is vertical, thereby occupying less space for transportation or storage.

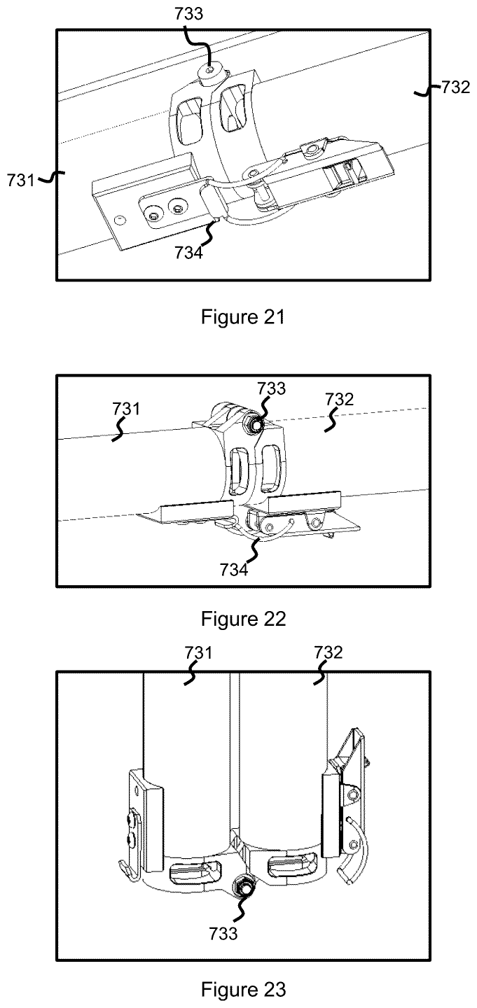

Additionally, referring to FIGS. 21 to 23, each pole arm 73a, 73b can also be folded in on itself. Each pole arm 73a, 73b is divided into approximately two equal parts: an outer part 731 and an inner part 732, joined together by a pole hinge 733 and an over-centre latch 734.

The axis of the pole hinge 733 is situated above the pole arm parts 731, 732, such that it keeps the outer part 731 and inner part 732 aligned with one another: the weight of the outer part 731 rotates relative to this pole hinge axis to simply to bring the confronting ends of the outer and inner parts together. Nonetheless, the two parts of each pole arm 73a, 73b can be securely locked together via the over-centre latch, situated underneath, and so diametrically on the opposite side of the pole arm to the pole hinge.

FIG. 23 shows the over-centre latch 734 when unlocked, and the outer part 731 of one of the pole arms 73a, 73b is folded in towards the inner part 732. Accordingly the effective length of the pole arm is halved.

When both pole arms are doubly-folded, both at their respective pole hinge 733, and hinge joint 86, the boom 71, rather than extending across a large length horizontally, instead occupies a smaller volume that is vertically-aligned and adjacent with the linkage 80. Rubber stops 735 ensure that contact, during folding and storage, between the components of the sensor assembly 70 does not cause damage. The lower strut 82 is also foldable in the same way. Advantageously, this allows the sensor assembly 70 to be collapsed quickly without tools.

Additionally, the lower strut 82 and the linear actuator 74 can be decoupled at their pivots on the chassis, such that the entire folded sensor assembly 70 can be laid back on to the top of the monitoring robot 8 during storage. This reduces the effective volume of the monitoring robot 8 further, and so makes it easier for an operator to ready the monitoring robot for transport to another farm plot as part of an efficient farming system 1. Nonetheless, as described, the farming system 1—incorporating the use of heterogeneous small, quiet, safe and efficient farming robots 8, 9—provides significant advantages over traditional farming methods that require human supervision. Autonomous farming operations are independent of daylight or human work hours, and a greater area of land can be used as arable land without tilling, levelling or deforestation, and despite restrictions on movement otherwise presented to large machinery. The application of additives or crop treatments can be far more discriminating, reducing injury to wildlife, minimising wastage, and increasing efficiency.

Finally, although the invention has been described in conjunction with specific embodiments thereof, it is evident that many alternatives, modifications and variations will be apparent to those skilled in the art. Accordingly, it is intended to embrace all such alternatives, modifications and variations that fall within the scope of the appended claims.

1. A farming method utilising autonomous farming robots that operate to monitor and tend to a farm plot, the autonomous farming robots including at least one monitoring robot and at least one tending robot, the method comprising:
monitoring the farm plot with the at least one monitoring robot, the at least one monitoring robot traversing the farm plot and generating, from a sensor set of the at least one monitoring robot, at least one farm plot data set;
processing the at least one farm plot data set to generate operating instructions for the at least one tending robot; and
executing the operating instructions at the at least one tending robot so that the at least one tending robot traverses the farm plot and performs weeding tending tasks on the farm plot,
wherein the at least one tending robot comprises a tool system for performing a weeding tending task on the farm plot.

2.-13. (canceled)

14. A farming system for monitoring and tending to a farm plot, the system comprising:
an autonomous monitoring robot for monitoring the farm plot, the autonomous monitoring robot comprising a sensor set;
an autonomous tending robot for tending to the farm plot, the autonomous tending robot comprising at least one tool for tending to a farm plot; and
a server in communication with the autonomous monitoring and tending robots via a network; wherein:
the autonomous monitoring robot is configured to traverse the farm plot and generate, from the sensor set, at least one farm plot data set, and transmit the at least one farm plot data set to the server;
the server is configured to receive and process the at least one farm plot data set to generate operating instructions for the autonomous tending robot, and transmit the tending instructions to the autonomous tending robot; and
the autonomous tending robot is configured to receive and execute the operating instructions so as to be further configured by the operating instructions to perform tending tasks on the farm plot using its at least one tending tool, including at least one of: seed-planting, weeding, and applying crop treatments.

15. The farming system of claim 29, further comprising a servicing station situated on the farm plot, the servicing station being arranged to provide servicing to at least one of the autonomous monitoring and tending robots including at least one of: replenishing their energy sources, transferring data, refilling consumables, switching tools and switching task configurations; wherein:
at least one of the server and the autonomous monitoring and tending robots are arranged to:
calculate an operations limit for one of autonomous monitoring and tending robots beyond which the one of the autonomous monitoring and tending robots requires servicing at the servicing station to continue effective performance of its operations;
determine the location of the servicing station and the one of the autonomous monitoring and tending robots;
determine a route for the one of the autonomous monitoring and tending robots that returns the one of the autonomous monitoring and tending robots to the location of the servicing station before exceeding the operations limit; and
guide the one of the autonomous monitoring and tending robots across the farm plot in accordance with the determined route to return the one of the autonomous monitoring and tending to the servicing station for servicing.

16.-20. (canceled)

21. The farming method of claim 1, wherein the tool system of the at least one tending robot comprises an electrical weeding device that is arranged to apply electrical energy to weed targets.

22. The farming method of claim 21, wherein the electrical weeding device comprises a high-power electrical pulse generator coupled to electrode applicators.

23. The farming method of claim 22, wherein the tending robot is arranged to:
determine a weed to be destroyed,
guide at least one the applicators towards a location of the determined weed, and
enable the electrical pulse generator so that an electrical pulse is transmitted through the weed.

24. The farming method of claim 23, wherein the tending robot is configured to position the electrode applicators at either end of the weed to be destroyed, with one electrode applicator being electrically connected to a lower or root portion of the weed to be destroyed, and the other directed towards an upper part of the weed.

25. The farming method of claim 23, wherein:
the operating instructions comprise task waypoints, each specifying a tending task to be performed at an associated location, the at least one tending robot receiving and executing the operating instructions thereby traversing the farm plot to perform tending tasks at their respective specified locations;
wherein task waypoints comprise weeding tending tasks to be performed at the location of weeds to be destroyed.

26. The farming method of claim 1, further comprising:
situating a servicing station on the farm plot, the servicing station being arranged to provide servicing to at least one of the autonomous farming robots;
calculating an operations limit for the at least one of the autonomous farming robots beyond which the at least one of the autonomous farming robots requires servicing at the servicing station to continue effective performance of its operations;
determining the location of the servicing station and the at least one of the autonomous farming robots;
determining a route for the at least one of the autonomous farming robots that returns the at least one of the autonomous farming robots to the location of the servicing station before exceeding the operations limit;
guiding the at least one of the autonomous farming robots across the farm plot in accordance with the determined route to the servicing station for servicing; and
servicing the at least one of the autonomous farming robots at the servicing station.

27. The farming method of claim 26, wherein the servicing station is arranged to provide automatic servicing to the at least one of the autonomous farming robots that includes at least one of: replenishing their energy sources, transferring data, refilling consumables, switching tools, and switching task configurations.

28. The farming method of claim 26, wherein the servicing station comprises a battery-swapping station at which an exhausted battery of the at least one of the autonomous farming robots can be exchanged for a charged battery during a servicing of the at least one of the autonomous farming robots at the servicing station.

29. The farming system of claim 14, wherein the at least one tending tool comprises an electrical weeding device that is arranged to apply electrical energy to weed targets.

30. The farming system of claim 29, wherein the electrical weeding device comprises a high-power electrical pulse generator coupled to electrode applicators.

31. The farming system of claim 30, wherein the tending robot is configured by the operating instructions to:
determine a weed to be destroyed,
guide at least one the applicators towards a location of the determined weed, and
enable the electrical pulse generator so that an electrical pulse is transmitted through the weed.

32. The farming system of claim 31, wherein the tending robot is configured to position the electrode applicators at either end of the weed to be destroyed, with one electrode applicator being electrically connected to a lower or root portion of the weed to be destroyed, and the other directed towards an upper part of the weed.

33. The farming system of claim 31, wherein:
the operating instructions comprise task waypoints, each specifying a tending task to be performed at an associated location, the at least one tending robot receiving and executing the operating instructions thereby traversing the farm plot to perform tending tasks at their respective specified locations; and
task waypoints comprise weeding tending tasks to be performed at the location of weeds to be destroyed.
